(19) United States
(12) Patent Application Publication
(10) Pub. No.: US 2024/0104521 A1
(43) Pub. Date: Mar. 28, 2024

(54) SYSTEM AND METHOD FOR COMPLIANCE-ENABLED DIGITALLY REPRESENTED ASSETS

(71) Applicant: SEALANCE CORP, Miami, FL (US)

(72) Inventors: Shlomit AZGAD-TROMER, Miami, FL (US); Matthew GREEN, Miami, FL (US); Eran TROMER, Miami, FL (US)

(73) Assignee: SEALANCE CORP, Miami, FL (US)

(21) Appl. No.: 18/273,449

(22) PCT Filed: Jan. 25, 2022
(86) PCT No.: PCT/US22/13601

§ 371 Date: Jul. 20, 2023

Related U.S. Application Data
(60) Provisional application No. 63/140,987, filed on Jan. 25, 2021.
(60) Provisional application No. 63/172,466, filed on Apr. 8, 2021.
(60) Provisional application No. 63/184,952, filed on May 6, 2021.
(60) Provisional application No. 63/152,655, filed on Feb. 23, 2021.

(51) Int. Cl. G06Q 20/06; G06Q 20/38; G06Q 20/40

(52) U.S. Cl. CPC G06Q 20/065; G06Q 20/382; G06Q 20/4014

(57) ABSTRACT

A computer-implemented compliance system is provided, configured to manage transactions over a digital asset network according to a compliance policy. The digital asset network is configured to enforce rules governing recording transactions on a public ledger. The compliance system is configured to determine that a requested transaction is in compliance with the compliance policy, generate at least partially encrypted compliance relevant auxiliary information (CRAI), the CRAI comprising information configured to facilitate independent verification of the compliance, and associate at least a portion of the CRAI with transaction information stored on the public ledger and store the associated CRAI in a storage location accessible via the digital asset network.

### TECHNOLOGICAL FIELD

The presently disclosed subject matter relates to systems for managing transactions on digital asset networks, and in particular to systems configured for enforcement of compliance policy on such networks.

### BACKGROUND

Public cryptocurrency systems offer many benefits that have made them highly successful, and could in the future allow them to replace some or all of the existing banking infrastructure. At the same time, they suffer from several limitations that reduce their utility.

Public ledgers such as Bitcoin and Ethereum do not fully protect the privacy of transactions, since all transactions are visible to the public. Participants on these networks instead adopt (possibly many) pseudonymous identifiers known as “addresses,” which provide a limited degree of privacy. However, the privacy guarantee this affords is tenuous—any party that can link one address to a user's real identity is likely to be able to recover the user's entire transaction history.

Public ledgers such as Bitcoin are “permission-less,” which means that any party can transact on the system. A consequence of this design is that users need not comply with Know Your Customer (KYC) or Anti-Money Laundering (AML) rules, or any other banking regulation that enforces limits on the flow of currency. Currently, compliance with banking regulations is enforced only at limited points in the cryptocurrency ecosystem, namely at exchanges and other Virtual Asset Service Providers (VASPs) that interface between cryptocurrency and the traditional banking system. These providers, in turn, exploit the public nature of cryptocurrency networks in order to analyze transaction patterns on cryptocurrency that they handle, e.g., to make judgements as to whether their customers are engaging in risky or potentially illegal transactions. This process involves a significant amount of guesswork and estimation from incomplete data. Nonetheless, a number of commercial products have been developed to perform this tracing and risk evaluation function.

Techniques such as “zero-knowledge proofs” can improve the privacy properties of a cryptocurrency system. Such techniques have been deployed as part of some cryptocurrency systems, which hide the identity of participants and the amount of each transaction. However, improved privacy has implications for regulatory compliance. As privacy techniques improve, the quality of on-chain transaction data tends to degrade, further reducing the accuracy of tracing and risk estimation data gathered from public transaction data. Privacy improvements are likely to be deployed in the future, which may pose a threat to the modern cryptocurrency ecosystem.

Some proposed solutions have been offered to this problem. One is to discard existing decentralized cryptocurrency systems and “wallet” software, and replace them with systems that are centralized, e.g., operated by traditional banking partners or VASPs. This would simplify regulatory compliance, potentially at the cost of fundamentally eliminating the decentralized nature of cryptocurrency technology. Other proposals would require users to voluntarily report on each transaction in a separate, centralized registry. This approach also requires new trusted parties, and moreover, will only be effective if all parties on the network participate.

### SUMMARY

The presently disclosed subject matter is directed towards a sealed asset platform (SAP) configured to provide a compliance layer and architecture to facilitate regulatory compliance systems to interoperate with existing cryptocurrency networks, without sacrificing user or transaction privacy.

The SAP may be configured to augment cryptocurrency transactions and wallets with compliance relevant auxiliary information (hereinafter, “CRAI”) to facilitate enforcing compliance, and to use the CRAI to cryptographically ensure adherence to compliance policies at each pertinent interaction. The SAP produces a sealed asset by augmenting some or all transactions and/or wallets with CRAI, either explicitly or implicitly.

The CRAI may comprise user identities (name, national identifiers, etc.), account numbers and institution identifiers, credentials issued by third parties (including, but not limited to, credit risk scores and/or accredited investor status), information related to user behavior and/or payment patterns (including, but not limited to, transaction history, fund provenance, source of funds, identities of counterparties, and/or transaction related information, and/or any other information deemed relevant for compliance. The CRAI may be mechanically recorded and/or deduced by the ledger mechanism (e.g., transaction history), or it may be provided by external parties (e.g., KYC information, and information from asset-aware services discussed below).

While the CRAI is recorded on the cryptocurrency ledger, it is not provided in an explicit form that can be read by anyone with access to the ledger, since this would compromise privacy. Rather, this information is protected cryptographically, and only permissible deductions are visible to the permissible parties for each transaction, for example as determined by a compliance policy.

Cryptographic protection of the CRAI may be provided by any one or more suitable methods. Non-limiting example of such methods may include:
1) Attaching the CRAI in encrypted form, such that decryption is only possible for authorized parties. This may comprise cryptographically ensuring, e.g., by zero-knowledge proofs, that decryption is possible and that the underlying data is correctly formed and certified. This method may allow other parties (e.g., the validators or “miners” of a distributed ledger) to recognize valid transactions even while lacking the ability to decrypt the respective CRAI.
2) Attaching the CRAI in an irrecoverable form (for example due to privacy concerns and/or data size constraints). For example, the CRAI may include only deductions and attributes (e.g., the nationality of a transaction sender, their total monthly transaction volume, etc.), whose correctness is cryptographically assured, e.g., by zero-knowledge proof.
3) Ascertaining and/or revealing the CRAI using cryptographic secure multiparty computation, carried out between the parties holding the CRAI and the parties that wish to inspect its properties.

As mentioned above, the sealed asset may facilitate enforcement of jurisdiction-specific compliance policies, for example one or more rules, implemented as computer programs that determine, for example based on data from one or more sources of information to, whether a given transaction should be permitted, what information must be revealed, and to whom. Such information may include, but is not limited to, one or more selected from transaction details (e.g., amount, time, etc.), user (i.e., sender) identifying information contained within the CRAI, recipient information (e.g., a cryptographic identifier such as a public key), public and/or private information stored on the cryptocurrency ledger, etc.

Compliance policies may be established by the authorities of a jurisdiction, by one or more consortia (e.g., self-governing industry associations) implementing their regulatory obligations, by regulated entities, and/or by any other suitable parties. For example, compliance policies may be determined by organizations or individuals to suit their specific requirements, such as preventing fund outflows above a certain rate, outside a designated allow-list of destinations, etc.

Compliance policies may specify, e.g., what CRAI information must be attached to each transaction, to whom it should be visible, whether it is conveyed explicitly or implicitly by cryptographically assured deductions, etc. For example, a policy may dictate that coarse-grained information will be revealed and certified to the transaction's recipient, that detailed wallet-owner identity would be attached in encrypted form that can be decrypted by authorized law enforcement under certain conditions, and that only transactions above a predetermined value will be visible in real-time to a designated authority. Compliance policies may place further restrictions on which transactions are allowed to occur in the virtual asset. For example, a compliance policy may specify limits on the amount of currency that a user may send within a single transaction, during a specific time period, to a specified party or group of parties, etc., including combinations of one or more such limits.

The SAP may be configured to define one or more sealed wallets for a user, for example comprising a data structure configured to facilitate binding a user's sealed asset holdings to the user's identity credentials. In particular, the SAP may be configured to define a sealed wallet in accordance with a jurisdictional policy with which the wallet is to be associated (e.g., the jurisdiction to which the wallet's owner is subject). This may entail, for example, facilitating conducting a KYC, AML, and/or CTF check by a regulated entity from a list prescribed by the policy, credential issuance by other authorized parties attesting to pertinent attributes of the wallet's owner, etc. These checks may be validated by a wallet identity provider (WIP), i.e., a party that maintains the ability to issue new sealed wallets. Individual assets may determine which identity providers are acceptable, for example by specifying policies that reject transactions by non-permitted WIPs.

The CRAI is generated or maintained by the user's wallet implementation, which is not directly trusted by others, wherein the SAP is configured to guarantee that each transaction complies with the policy with which it is associated. Accordingly, the SAP may provide a mechanical way to check every transaction for such compliance, so that non-compliant candidate transactions are automatically rejected.

A sealed asset may be a completely new virtual asset, or it may be obtained by augmenting a pre-existing native, i.e., legacy, asset (e.g., an existing cryptocurrency such as Bitcoin) with suitable CRAI (e.g., yielding a “sealed Bitcoin”). In the latter case, the SAP is configured to perform a sealing process in which a unit of the native asset is be converted into a unit of the sealed asset. The requisites are defined by the policy, and may consist of, for example, manual KYC/AML/CTF checks by a regulated entity from a list prescribed by the policy.

All sealed assets, once created, may be transacted within a compliant pool comprising a plurality of sealed wallets and a plurality of sealed assets each associated with the same and/or a compatible compliance policy. Since different wallets may be subject to different policies (depending, e.g., on the jurisdiction under which their owners operate), a single sealed asset may be associated with a plurality of compliant pools. Moving sealed assets between compliant pools is subject to the policies of both the origin and destination pool; these policies may allow unlimited passage, may impose constraints (e.g., in amounts or in mandatory reporting), or may subject passage to approval by designated gateways.

The SAP may be further configured to facilitate “breaking the seal” of a sealed asset, i.e., extracting the underlying native therefrom by dropping the CRAI associated therewith, for example for a sealed asset created by sealing a native asset as described above. This can be done separately for any unit of the sealed asset, for example by its owner. In such a case, the extracted native asset is no longer within the compliant pool, other parties would recognize it as an asset whose compliance is no longer ensured by the SAP, and may thus reject any transactions thereof until it is sealed again. In this case, sealing may be done by the aforementioned policy-determined process. According to some examples, the SAP may be configured to automatically reseal the asset if it has not yet been transferred to other users (and is thus recognizable as already associated with the dropped CRAI). The ability to break the seal may thus provide a measure of safety to facilitate protecting against avoidance of loss of funds, e.g., in case of system malfunction.

The SAP is thus configured to permit transactions, within the compliant pool, that correctly convey and propagate the CRAI of the associated wallets and related transactions (as defined by the policy). This may comprise taking into account information about the transaction's counterparties, the upstream transactions whose resulting funds are being used, and the CRAI associated therewith.

According to some examples, the SAP may facilitate one or more tailored means for propagating CRAI through a plurality of comingled systems, e.g., by a custodian who serves many customers, by decentralized exchanges and/or other decentralized finance systems, or by privacy-enhancing systems such as mixnets. Accordingly, the SAP may be configured to accurately convey the CRAI when funds are withdrawn from the commingled systems.

The SAP may be configured to provide an assurance of privacy-by-default, and protection of all private information unless and until the jurisdictional policy dictates that it should be revealed. This may comprise protection-by-default of users' personally identifiable information, such as KYC information and transaction history, which it would be unacceptable to reveal except to duly authorized parties under policy-specific conditions.

The SAP may support sealed assets, carrying CRAI, and enforcing policies for any type of virtual assets. In this document, the terms “virtual asset,” “digital asset,” and “asset” are used interchangeably to refer to any asset whose ownership and transfers may be digitally represented on computer systems. This may include, but is not limited to, fungible assets (for which all units have equal value and no inherently distinct identity, e.g., most cryptocurrencies, stablecoins, fungible tokens, and bank-issued digital currencies), non-fungible tokens representing ownership or control of distinct (physical or virtual) assets, assets that rendered non-fungible by additional reasoning on their provenance (e.g., “colored coins” or coins whose value is affected by provenance due to chain analysis), etc.

Such assets may be created on, and defined primarily by, a blockchain ledger (e.g., most cryptocurrencies, including stablecoins), and/or represent ownership of other assets (e.g., digital tokens representing ownership of financial instruments or assets such as securities, derivatives, merchandise, real estate, collectibles, etc.).

The SAP may operate on a public blockchain-based ledger, on a private or permissioned blockchain-based ledger, and/or on any other suitable digital system capable of representing asset ownership and asset transfer events with well-defined semantics, including databases configured to represent such information. This may include, but is not limited to, payments and/or settlement services that digitally convey transfers of currency, securities, or other assets.

The SAP may be configured to preserve CRAI and to enforce compliance policies across transactions involving multiple types of sealed assets and/or multiple blockchain-based consensus systems (or other systems for representing virtual assets), creating a unified compliant pool. For example, the SAP may track CRAI and enforce compliance across a transaction that exchanges one sealed BTC coins tracked by the Bitcoin blockchain for 35 sealed ETH coins tracked by the Ethereum blockchain.

According to an aspect of the presently disclosed subject matter, there is provided a computer-implemented compliance system configured to manage transactions over a digital asset network according to a compliance policy, the digital asset network being configured to enforce rules governing recording transactions on a public ledger, the compliance system being configured to:
determine that a requested transaction is in compliance with the compliance policy;
generate at least partially encrypted compliance relevant auxiliary information (CRAI), the CRAI comprising information configured to facilitate independent verification of the compliance; and
associate at least a portion of the CRAI with transaction information stored on the public ledger, and store the associated CRAI in a storage location accessible via the digital asset network.

It will be appreciated that herein the specification and appended claims, unless otherwise clear from context, the terms “compliance,” “compliance system,” etc., are used with reference to internal policies, e.g., those defined by the compliance policy, and not necessarily to compliance with relevant regulations, laws, etc. While there may be overlap between the two, i.e., a compliance policy may be defined to facilitate observance of relevant regulations, laws, etc., the intention in the presently disclosed subject matter is in connection with policies defined by the system, unless otherwise clear from context.

The compliance policy may be further configured to:
associate encrypted regulatory information with one or more of a user's transactions, the regulatory information being decryptable by a relevant regulatory agent;
generate a report comprising information about the one or more transactions; and
cryptographically store the report with the associated regulatory information.

The compliance policy may define one or more conditions constituting suspicious activity, the compliance system being configured to determine that the one or more transactions constitutes the defined suspicious activity. The compliance system may be configured to cryptographically store the report with the regulatory information such that knowledge of the existence of the report is encrypted. Information for decrypting the regulatory information may be unavailable at least to the user. Non-limiting examples are described hereinbelow as Example #5 of compliance policies (Suspicious activity reporting).

Associating the regulatory information and generating the report may be performed by a wallet associated with the user. Non-limiting examples are described hereinbelow as Example #13 of compliance policies (Foreign account reporting).

The storage location may be the public ledger of the digital asset network. Associating the CRAI with the transaction may comprise attaching the CRAI to the transaction.

The storage location may be a publicly accessible server, wherein transaction information recorded on the public ledger of the digital asset network refers to the storage location.

The policy may define one or more attributes of a forbidden transaction, the compliance system being configured to block execution of a transaction deemed forbidden by the compliance policy. Non-limiting examples are described hereinbelow as Example #14 of compliance policies (Blocking and sanction enforcement).

The policy may define one or more attributes of a transaction requiring a deduction, the compliance policy being configured to identify when a transaction requires a deduction, calculate the amount of the deduction, and initiate a transaction to satisfy the required deduction. Non-limiting examples are described hereinbelow as Example #11 of compliance policies (Tax payments).

The compliance system may be configured to utilize functionality of the digital asset network to check the validity of CRAI attached to transaction information, thereby verifying compliance with the compliance policy.

The compliance system may comprise a plurality of sealed wallets defined by the compliance policy, the sealed wallets being configured to reason over the CRAI to determine if a requested transaction is in compliance with the compliance policy.

At least some of the sealed wallets may be implemented as code stored on the digital asset network.

The compliance system may be further configured to reason over CRAI associated with one or more transactions.

The CRAI may comprise a proof that the transaction complies with the compliance policy.

The CRAI may comprise compliance information relevant to a determination of compliance of a requested transaction with the compliance policy.

The compliance information may relatee to the identity of one or more parties to the transaction.

The compliance information may relate to details of the transaction.

The compliance system may further comprise an identity provider configured to verify information corresponding to a user, and to issue an identity certificate to the user upon the verification.

The identity certificate may comprise:
a public component comprising identity information of the user; and/or
a private component that comprises cryptographic key material

The identity certificate may constitute at least a portion of the CRAI.

The compliance system may be configured to augment a native asset associated with the digital asset network by attaching CRAI thereto in accordance with the compliance policy, thereby producing a sealed asset.

The compliance system may be configured to disassociate CRAI from a sealed asset, thereby extracting the native asset therefrom.

The compliance system may be further configured to define a compliant pool comprising sealed wallets and sealed assets defined by compatible compliance policies.

The compliance policy may define which compliance policies are compatible.

The compliance policy may define conditions for a sealed asset to leave the compliant pool.

The compliance system may be further configured to prevent transactions involving one or more parties.

The CRAI may comprise a regulatory escrow access field configured to facilitate third-party verification of each transaction.

The compliance system may be further configured to attach to a transaction an encoded mathematical function related to the transaction.

The compliance system may be further configured to analyze one or more transactions for suspicious activity.

Encryption of at least some of the CRAI may facilitate verification thereof without revealing it contents.

The verification may comprise a zero-knowledge proof.

Encryption of at least some of the CRAI may be irrecoverable.

The transaction information may comprise one or more selected from a group consisting of a cryptographic identifier of a sender of the transaction, cryptographic identifier of a recipient of the transaction, and transaction details.

The transaction may comprises transferring currency.

The currency may be a cryptocurrency.

The compliance system may be configured to manage transactions over a digital asset network according to at least one compliance policies selected from two or more compliance policies.

The compliance system may comprise one or more computer processors and memory storing executable instructions direct the system to operate as configured.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a compliance system and a digital asset network on which it is configured to manage transactions according to the presently disclosed subject matter;

FIG. 2 illustrates a sealed asset defined by the compliance system illustrated in FIG. 1;

FIG. 3 illustrates a gateway of the compliance system illustrated in FIG. 1, in communication with multiple compliant pools and native assets; and

FIG. 4 illustrates an exchange asset-aware service of the compliance system illustrated in FIG. 1.

### DETAILED DESCRIPTION

As illustrated in FIG. 1, there is provided a compliance system configured to manage transactions over a digital asset network. The digital asset network is configured to enforce rules (not necessarily defined by or the compliance system) which govern recording transactions on a public ledger. The compliance system is configured to enforce one or more compliance policies in the transactions it manages. It will be appreciated that FIG. 1 illustrates only one example of how the compliance system may be implemented and is not meant to be limiting, neither in the components illustrated nor the relationships therebetween.

The compliance system may comprise a sealed asset platform (SAP). The SAP may comprise and/or be configured to operate in conjunction with some or all of the following:
1) A wallet implementation configured to facilitate users to interact with the SAP. According to embodiments, the wallet implementation is a software application configured to communicate with the SAP in order to facilitate issuing, receiving, and conveying the state of one or more transactions. The wallet implementation may also be configured to manage cryptographic identifiers that control the spending of currency, and to record identification credentials belonging to the user. It may run locally or remotely and/or may be augmented by hardware.
2) A consensus system configured to update the cryptocurrency ledger and enforce rules for governing which transactions are allowed. The consensus system may comprise a single, centralized machine, or it may comprise a network of independent and decentralized systems. Examples of consensus systems include, but are not limited to, the Bitcoin and Ethereum technical platforms, which use blockchain technology in order to construct a ledger in which transactions are restricted by a set of agreed-upon consensus rules.
3) One or more compliance policies, each comprising a set of rules that define, for each transaction in a sealed asset (below), whether it is deemed compliant and thus permitted, as well as which information it must reveal and to whom.
4) A sealed asset, comprising a virtual asset capable of enforcing compliance policies using the SAP. As illustrated in FIG. 2, the sealed asset may comprise a native asset, comprising a pre-existing virtual asset, which has been augmented by the SAP with compliance relevant auxiliary information (CRAI), thereby facilitating enforcement of compliance policies in connection therewith.
5) A compliant pool, comprising a set of all transactions, across one or more ledgers and one or more sealed assets, that satisfy the associated compliance policies.
6) An identity provider (IP) configured to issue identity credentials to users on the system. The SAP may comprise multiple IPs, each of which individually uses a different approach to verifying users' identities. An identity credential, once issued, is a digital document that asserts the user's identity as well as necessary information about the user and his/her accounts. IPs may be further configured to verify the identity of a user at any point after his identity credential has been issued.
7) A policy issuer configured to facilitate creation of a new compliant pool, by determining the compliance policies that apply to that pool. The compliance policy in turn determines which assets may be transacted in that pool, and how these transactions should work.
8) Gateways configured to allow the transfer of assets into and out of the compliant pool. This may include transfers of an asset between different compliant pools that carry different compliance policies (e.g., policies that differ between legal jurisdictions). It may also include gateways that allow assets to enter the compliant pool from outside sources, such as traditional cryptocurrency assets.
9) One or more asset-aware services (AASs), configured for interacting with sealed assets, while preserving meaningful information about the asset's CRAI. An asset-aware service may be within and/or outside of the consensus system. It may include centralized or decentralized exchanges, mixes, inter-blockchain communication systems, and/or other suitable applications.

Several of the above components may be co-located in a single machine and/or implemented as functions of a single software program (e.g., an identity provider may also issue assets and/or use wallet implementation as an end-user). Alternatively, a single component may be implemented in a distributed fashion such that the role of that component is jointly performed by multiple parties.

### Wallet Implementations and Sealed Wallets

The wallet implementation may comprise software and/or hardware that communicates with the SAP, executes transactional operations on behalf of the user, and conveys the state of the SAP to the user.

The wallet implementation may also be configured to manage cryptographic identifiers (i.e., keys) that are associated with each user, and which control the spending of assets owned by that user. Wallet implementations may also store, process, and convey CRAI associated with each user and the transactions that user is involved in. For example, they may be configured to record identification credentials belonging to a user.

Different wallet implementations may communicate with a single instance of an SAP (e.g., by following compatible protocols), and are thus interoperable. A wallet implementation may be configured to serve numerous users, e.g., each with their own cryptographic identifiers and credentials.

An instance of a wallet implementation, together with the cryptographic identifiers and credentials associated with a given user, may constitute a sealed wallet.

The wallet implementation may make use of dedicated hardware for secure data storage, or for performance acceleration. The wallet may run on the user's local device, such as a phone or a personal computer, or it may run on a remote server (e.g., via Software as a Service, or Infrastructure as a Service, as part of some related third-party service, etc.), for example being accessed through the Internet. The wallet functionality may be split among the local computer, remote server, and hardware (e.g., secret keys and credentials might be stored on the local computer or hardware for security, interaction with the user handled by the local computer for responsiveness, and synchronization with the blockchain handled by a remote server for efficiency). All of these components are augmented to convey and act on CRAI as required by relevant policies.

A sealed wallet may be operated and controlled by the user owning the assets. They may also be operated and controlled by a separate party constituting a wallet service provider (WSP). Various combinations of the two are possible. For example:
In a custodial wallet, the wallet implementation is fully operated and controlled by a WSP that is distinct from the asset owner (analogously to a traditional bank deposit account). The WSP holds the pertinent cryptographic identifiers and credentials, and thus full technical control of the assets. Users exercise their ownership rights by instructing the WSP to carry out actions on their behalf, through some interface (e.g., a website) offered by the WSP. A single WSP may serve many different users, may commingle assets owned by different users under a single cryptographic identifier in its own sealed wallet, and may not hold in custody the full sum of its users' deposits (i.e., fractional reserve).
In a self-custodial wallet (also called a self-hosted wallet or unhosted wallet), the wallet implementation is fully operated and controlled by the user owning the assets (for example analogously to traditional cash wallets). There is no reliance on external parties other than for interaction with the blockchain ledger system (to receive updates, and to submit transactions in their fully-formed broadcast-ready state). In particular, the private cryptographic identifiers and credentials belonging to the user are stored in software and hardware operated by that user (analogously to carrying ID cards in a traditional wallet).

It will be appreciated that the custodial wallet and self-custodial wallet represent two extreme cases, and various combinations combining aspects of each are possible without departing from the scope of the presently disclosed subject matter, mutatis mutandis. For example, starting from a self-custodial wallet, the wallet implementation may be changed so that one or more of the following capabilities are delegated to a WSP:
spending authority, i.e., storage of private cryptographic identifiers allowing spending of the funds, along with implementation of the requisite computational procedures;
credentials authority, i.e., storage of credentials associated with the user and attesting to their private information, along with implementation of the procedures for exposing these credentials;
monitoring authority, i.e., storage of private cryptographic identifiers, or implementation of communication protocols, allowing the WSP to view transactions to which the user is a counterparty (in part or in whole, as recipient, sender, or both, some or all transactions);
censorship authority, i.e., making the WSP a choke point that can block the user from issuing transactions; and/or
acceleration and ledger tracking, i.e., delegation of technical components, such as acceleration of computational operations or synchronization with a distributed ledger state, that may be too slow or expensive to implement on the user's own device.

If all capabilities are delegated from the user to a WSP, this results in the wallet implementation being a custodial wallet.

Wallet implementations and WSPs may play crucial roles in handling CRAI, i.e., producing and keeping records of some types of CRAI (e.g., transaction history), performing deductions based on CRAI, producing cryptographic claims about CRAI to be verified by others, checking the validity of CRAI and cryptographic claims about CRAI that are produced by others, and/or conveying CRAI to and from users and integrated services.

Sealed wallets may include smart contracts, i.e., autonomous or semi-autonomous computer programs executed by the distributed ledger. Such smart contracts may own assets, in the sense that they control all movement and disbursement of these assets. For example, smart contracts may include multi-sig wallets, decentralized exchanges, automated market makers, and/or decentralized loan-making services. Smart contracts may be designed as sealed wallets by attaching policy-mandated CRAI to them, and subjecting their inbound and outbound transaction to the policy mandates, as for any other sealed wallet. The policy may have rules specific to such sealed wallets, e.g., requiring their associated CRAI to identify the party that launched the smart contract.

### Identity Provider (IP)

The Identity Provider is configured for issuing identity certificates to end-users. In its most general form, the roles of an IP are to (1) verify the identity information corresponding to each user, and (2) issue a cryptographic certificate, called an identity certificate, to the user. The user may then incorporate the resulting certificate as a CRAI in their sealed wallet, and subsequently present it (or attestations to its content) within transactions, as dictated by the applicable compliance policy.

Identity providers may be identified by one or more public cryptographic identifiers, such as public keys for a digital signature algorithm. These identifiers are in turn cryptographically bound to the identity certificate, which is an authenticated cryptographic data structure that entombs information about the user's identity in a machine-readable form. An identity certificate may, in some instantiations, consist of one or both of: (1) a public component that embeds the identity information for the user (or a compressed cryptographic representation thereof), and (2) a secret (i.e., private) component that comprises cryptographic key material. Identity certificates function similarly to standard Public Key Infrastructure (PKI) certificates, in that Identity Providers may certify the identity of other Identity Providers, which may in turn certify the identity of end-users. Each certificate may embed a defined validity time period, and may include a mechanism allowing IPs to revoke certificates that have been misused or stolen.

Sealed asset issuers may select one or more IPs to provide identity services to a given asset. This list can be specified explicitly at the time the asset is issued, or it may be updated over time. In order to participate in creating transactions within the compliant pool, a sealed wallet must at minimum be provisioned with a valid identity certificate from one or more of the allowed IPs. The compliance policy for a given asset is used to specify which IPs are required for transactions with a given asset, for example as described below.

The identity certificates issued by IPs may comprise attributes required or allowed by the applicable compliance policy. For example, these may include, but are not limited to, one or more selected from:
1) basic “Know Your Customer” information, such as the owners' name, type of entity (individual/corporate), nationality, address of residence, date of birth, national identifier, passport number, tax identifies, driver's license number, contact details, etc.;
2) biometric information of the owner;
3) information (for example as per the above) for parties authorized to transact in these wallet (which may be different from the owner);
4) identification of the wallet owner as a financial institution, a Virtual Asset Service Provider, a custodian service, etc.;
5) relation of the wallet's owner to accounts or digital identities on other platforms, such as social network usernames, customer accounts at private companies (including financial institutions), employee databases, self-sovereign identity networks (blockchain-based or otherwise), Internet domain names ownership, etc. This may be done directly, or indirectly through identity-linking services such as Keybase; and/or
6) an assessment, e.g., by the IP based on its own KYC/AML risk-based policy, of the wallet's risk score.

It will be appreciated that some of these attributes may be privacy-critical and accordingly not to be revealed unselectively. The relevant compliance policy may dictates which attributes are revealed, to whom, and under what conditions. The SAP may comprise a cryptographic protocol configured to facilitate enforcement of this policy.

Identity certificates may comprise further information, for example obtained in the course of customer due diligence and/or enhanced due diligence processes, including, but not limited to:
1) corroborating activity information consistent with the customer's transaction profile, obtained through third party providers or through public searches;
2) the customer's IP address;
3) information obtained through the use of blockchain analytics;
4) details about the nature, end use or end user of the transacted item, and the purpose of the transaction;
5) proof of funds ownership and/or sources of wealth or funds;
6) the identity and the beneficial ownership of the counterparty;
7) export control information and/or other licenses and/or certification;
8) other identification information relating to the originator or the beneficiary of the transaction; and/or
9) other customer information, transaction history, and additional transaction data that it or its counterparty VASP obtained from its customer.

In addition, identity certificates and other information constituting portions of CRAI may be revised and updated from time to time, e.g., in compliance with regulatory requirements, for identity verification and authentication purposes, and/or for ongoing due diligence, by undertaking reviews of existing records and matching the information with new data that becomes available.

Identity certificates may facilitate VASPs to:
1) enable a VASP to locate counterparty VASPs for virtual asset transfers;
2) enable the submission of required and accurate originator and required beneficiary information immediately when a virtual asset transfer is conducted on a decentralized platform;
3) enable VASPs to submit a reasonably large volume of transactions to multiple destinations in an effectively stable manner;
4) enable a VASP to securely transmit data, i.e., protect the integrity and availability of the required information to facilitate record-keeping using CRAI;
5) protect the use of such CRAI by receiving VASPs or other obliged entities as well as to protect it from unauthorized disclosure in line with national privacy and data protection laws;
6) provide a VASP with a communication channel to support further follow-up with a counterparty VASP for the purpose of due diligence against a counterparty VASP; and/or
7) facilitate the option of requesting information on a certain transaction to determine if the transaction is involving high risk or prohibited.

As will be described below, the compliance system may comprise an identity conveyance system configured to facilitate an IP to accomplish some or all of the above.

Asset-Aware Services (AAS) Sealed assets generally exist in one of two states. In their ordinary state, they reside within the compliant pool. While in the compliant pool, assets can be transmitted between wallets as permitted by the asset's compliance policy. However, some applications necessitate more complex financial interactions that cannot be fully encoded by a simple globally enforced policy.

An example of such an application is a service that receives and commingles assets from multiple users. Services with this characteristic include asset exchanges (whether centralized or decentralized); many decentralized finance applications; coin mixing networks; custodial solutions; and others. For example, in an asset exchange, a plurality of users send assets to the control of an exchange system, which may commingle multiple users' assets in the same wallet; they then conduct trades to acquire different assets (likewise held in commingled wallets) and eventually withdraw various assets from the exchange.

An asset-aware service (AAS) is thus configured for processing (e.g., sending, receiving, and interacting with) one or more sealed assets in a more complex manner than is allowed by the asset's basic compliance policy. An AAS is permitted to send, receive, or even mix together currency from different end-users. The AAS is responsible for ensuring that CRAI information is correctly reflected on all assets exiting the service into a compliant pool. An AAS may also augment transactions' CRAI with additional information available to it, which may not be otherwise deducible from prior CRAI and transaction history. Accordingly, when assets in the exchange belong to the service's users, their CRAI may reflect this ownership status whenever they enter and leave the service, and whenever they are exchanged for other assets within the exchange. This may require logic that is specific to the application supported by the service.

Sealed assets' compliance policies may support AASs in various ways, all of which authorize some AAS to perform transactions or convey CRAI that may not be otherwise allowed by the compliance policy. For example:
1) Compliance policies may include an “allow-list” of AAS parties. These parties would be authorized, and hence trusted, to track users' CRAI for funds that flow internally, and convey it at outbound transactions.
2) Compliance policies may authorize specific protocols (i.e., distributed algorithms) to mechanically track CRAI as they flow within protocols. For example, a mixnet system may be augmented to cryptographically convey CRAI along with the mixed transactions, in a way that achieves the mixnet's privacy goals as observed by the general public including nefarious eavesdroppers, but enables forensic investigation by authorized law enforcement. Concretely, when applied to a blockchain platform that supports smart contracts, this may realized by creating a smart contract that implements the protocol (or pertinent portions thereof), performs CRAI tracking for the assets through it, and has been reviewed to ensure that its CRAI tracking is correct and sound. The smart contract's address may then be added to an AAS allow-list within the policy. Similarly, “Layer 2” asset transfer protocols for virtual assets, such as Bitcoin's Lightning Network, or Bolt Labs's zkChannels based on the Bolt protocol, can also be augmented at the protocol level to convey CRAI reflecting the true ownership of the assets rather than the mechanism that transfers them over the underlying (“Layer 1”) distributed ledger. Likewise, rollups systems can be augmented to convey CRAI, for example as discussed below.
3) The aforementioned AAS allow-lists may be directly embedded into the policy, and/or may be delegated to external parties such as regulatory bodies, using cryptographic means (e.g., digital signatures). For example, a policy may include the cryptographic identifier of some third-party service, which itself publishes a list of allowed AAS public keys in a well-defined location. This allows the list of authorized AASs to change over time. (This may be repeated. For example, a policy may cryptographically delegate authority to a party which in turn is authorized to delegate to another party or parties the authority for naming AASs. Similarly, such authority can be distributed among a group of multiple parties using well-understood techniques such as multisig or threshold cryptography.) The same mechanisms may allow the authority of an AAS to be revoked, for example in the event that a specific AAS is compromised or fails to correctly produce CRAI.
4) An AAS may be authorized to act within specific behavioral boundaries. For example, a compliance policy may embed a specific set of parameters that define the types of activity that may be supported by an AAS. These parameters may specify restrictions on certain types of activity, e.g., restrictions on allowed transaction addresses, total funds exchanged, and types of assets supported. As a concrete example, an AAS may be authorized to act as a gateway service between some pools (e.g., compliant pools) but not between other pools.

The compliance policy may grant the AAS the flexibility to override the default CRAI propagation, based on assets and wallets, in ways such as the following:
1) Identifying assets that are commingled within one wallet owned by the AAS operator, as being custodied on behalf of one or more other user wallets. Accordingly, propagate CRAI corresponding to the actual owners (such as their origin wallet and transaction history). Thus, when assets are withdrawn from the commingled wallet, they would carry the CRAI of the actual user's wallet, rather than merely that of the AAS operator that custodied the assets.
2) Identifying assets, denominated in one sealed asset, as originating from a trade or exchange of a prior, different sealed asset. Accordingly, propagate CRAI corresponding to the prior asset (such as its origin wallet and transaction history).
3) Extending the above to the case of fractional reserve, wherein the custodian wallet may hold less than the total funds put in custody with the custodian by its users. Thus, a custodian AAS may accept deposits from one or more users into its own custodian wallet, withdraw some of these assets for its own purposes (e.g., to make an interest-bearing loan), deposit back some assets into its custodian wallet, and finally allow users to withdraw their assets from the custodian wallets. The AAS may be configured to remove irrelevant assets in intermediate steps, and include in the CRAI only the economically pertinent transactions (in this case, the user's deposit and withdrawal).

The AAS may be further configured to add additional information to the CRAI of the relevant transactions and wallets, for example if authorized by the compliance policy. For example, an exchange AAS may annotate transactions with information about exchange rates and market conditions during a trade.

### Data Platform

In many instances, a compliance-enabled cryptocurrency system may require the collection and dissemination of aggregate data or statistics about transactions that occur on the system. This data may include, for example, statistical information about transaction volume and flow for one or more sealed assets, exchange price information for assets where such information is available, as well as other data (e.g., exchange trade volume) that may be produced by AASs. Statistics may also be specific to the activity of a specific user's wallet, e.g., the calculation of a “risk score” based on that user's activity. These statistics may further be broken down by wallet attributes dictated by the policy, allowing statistics such as “total funds held in wallets marked as bank-owned,” or “total daily flow from wallets tagged as self-custodied to wallets tagged as exchange-owned.”

This aggregate data collection may serve two purposes. First, it may facilitate the SAP to provide customers and/or regulators with aggregate information about the current state of the system, while simultaneously preserving the privacy of individual transactors to the maximum degree possible. This information allows customers and/or regulators to detect and respond to trends.

Second, it may facilitate informing compliance policies that require such aggregate data. For example, a compliance policy may require issuing Suspicious Activity Reports (SARs) based on contextual information, such as overall transaction volume in that asset (since transactions that are larger compared to total volume may be an indicator of market manipulation). To enable such policies, the data platform can publish necessary data to participants on the network in an authenticated form, via “data oracles.” These are specialized systems that allow for the publication of such data (either on the ledger or off of it.) The data values published via these data oracles can be used as input to specific compliance policies.

It will be appreciated that the term SAR as used herein may include all forms of mandated reporting in various jurisdictions and organizations, for example including those covered in the US by regulations, e.g., “Cash Transaction Reports” (CTR) obligations, etc.

The data platform may comprise the following components: (1) a privacy-preserving data collection architecture, which consists of one or more nodes (whether decentralized or centralized servers) responsible for collecting and aggregating statistical information about transactions that occur on the network, (2) an Application Programming Interface (API) for participants to obtain statistical data and make queries about the state of the network, (3) a set of data “oracles” that publish this data for use by participants in the network, and (4) a data dashboard that conveys human-readable summaries to authorized parties.

The data platform is designed to collect information from individual transactors using privacy-preserving techniques.

The data platform may comprise data access control mechanisms, which restrict data visibility to certain parties (e.g., organizations, units within organizations, or roles). The access policy may be specified by the compliance policy and/or by intra-organization policies. For example, the compliance policy may specify that a regulatory body has access to wallet owner identity information in certain transactions; and the regulatory body's internal policy may specify that a certain investigator can access this information only if the transaction's owner's address is in a certain district or if given approval from their manager. This compound policy would be enforced by the data platform.

### Gateways

Gateways are configured to facilitate movement of assets from one compliant pool to another compliant pool, or to allow native assets to enter or exit the compliant pool. Gateways are similar to AASs, in the sense that they represent an in-built “exception” to the restrictions imposed on assets by the compliance policy associated with the pool. (In fact, a gateway can be considered as a specialized AAS.) For example, as illustrated in FIG. 3, a single gateway may enable assets to transition between multiple compliant pools and native assets.

The identity of the authorized gateways may be determined by the compliance policy associated with each compliant pool. This specification can be done by identifying the exact cryptographic identity (e.g., public key) of each gateway provider within the policy, or by specifying a more complex mechanism in the compliance policy to authorize new gateways without changing the compliance policy.

### Compliance Policies

Each sealed asset is associated with one or more compliance policies. The compliance policy comprises a set of machine-readable rules that determine under what conditions a transaction within the compliant pool will be allowed. Compliance policies may enforce one or more selected from the following aspects of how a sealed asset is transacted in the compliant pool:
which assets may be allowed to transact within the compliant pool;
which Identity Provider(s) must issue identity certificates to the users who transact with the assets, and what conditions must be enforced over the users' identities;
which asset-aware service and gateways are supported by the asset;
what information, from the CRAI associated with every wallet and transaction, is revealed to which parties, and under what conditions;
what aggregate information, which may depend on all transactions, wallets and their respective CRAI, is revealed to which parties, and under what conditions; and/or
any other restrictions that can be enforced over the transaction data, identity data, private and public data published in well-defined locations.

Nature of a Compliance Policy

A compliance policy comprises a set of rules that can be evaluated by a computer system in order to determine whether the transaction should be allowed. It may also specify a set of “side effects” that are caused by a transaction attempt, such as the publication of a Suspicious Activity Report (SAR) or the production of statistical data for use by the data platform. In a typical embodiment, these rules will be expressed in the form of a computer program or logical circuit that takes in various data related to the transaction, reasons over this data, and outputs a decision that either approves or disallows the transaction as well as some output data that can be transmitted on the ledger.

A policy issuer selects the compliance policy (or multiple policies) that are used by default in each new sealed asset. (It will be appreciated that a collection of multiple policies may be implemented by specifying a single policy that combines multiple policies; accordingly, herein the present disclosure, a “policy” explicitly includes any such collection of policies and/or a single policy.) When multiple policies are used, the asset issuer must specify how the different policies interact, e.g., whether all policies must be simultaneously satisfied or whether only one or a subset must be.

Examples of policy issuers include, but are not limited to, self-governing industry organizations, companies, nonprofit organizations and/or consortia thereof, central banks, regulatory bodies, law enforcement agencies, regulated entities, and individuals. Policies may reflect requirements applicable worldwide, for a specific jurisdiction, for a specific organization, for a specific individual, and/or for any group of the aforementioned. The SAP may be configured to allow policies to be issued by a specific party, by some designated set of parties, or permissionless, i.e., by any party.

An SAP may be configured to allow policies to be issued and revised by any of the above, by some designated party, or by some designated group of parties.

Multiple policies may be in effect simultaneously for the same sealed asset. Different sealed assets may share the same compliance policy, or portions of their compliance policy. Assets may also use a unique policy that differs from other assets.

Policy Inputs

The compliance policy may reason over a large and diverse set of data sources, made available by our system, in order to arrive at its decision to allow or disallow a transaction. These inputs may derive from one or more selected from the following data sources:
transaction inputs, i.e., information related to the transaction itself, such as the purpose of the transaction, the amount and currency transacted, the address of the sender and receiver, and the time of the transaction;
transaction-adjacent data, i.e., additional auxiliary data fields embedded in transactions when represented in a form recognized by the consensus system. These can include unstructured data fields (such as memo fields already present in existing currencies) that are visible to participants on the network, as well as structured fields that have meaning understood by the consensus system;
data from one or more identity credentials provided to a sealed wallet (belonging to sender or recipient), which are authorized by an Identity Provider, and various information from these identity credentials can be used as input to the compliance policy;
public “oracle” data broadcast by trusted parties (known as “oracles”). This data may be published via the consensus system or some other channel, and is typically cryptographically authenticated by the issuing party. Examples of this public data may include asset price data; and/or
consensus system data, such as the time or ledger length at the time when the transaction was added to the ledger, or other information present on the ledger.

The above list is not exhaustive. In principle, compliance policies may reason over any data that is available at the time that a transaction is created or added to the consensus system's ledger.

Policy and Data Confidentiality

Two important conditions for the design of a compliance-enabled sealed asset are privacy (confidentiality) and soundness. The first requires that transactions should not leak confidential information to unauthorized participants, even when that information is needed in order to verify that a compliance policy is satisfied. This privacy requirement is particularly important in public consensus systems, where the task of validating the correctness of transactions on the ledger often falls to untrusted volunteers. Soundness means that the consensus system participants and third parties must be convinced that the transaction does indeed satisfy the compliance policy, even when they cannot see all of the inputs to the policy evaluation.

The apparent contradiction in these requirements is resolved through the use of cryptography. In particular, this requires that the correct evaluation of compliance policies must be enforced using privacy-preserving techniques, such as zero-knowledge proofs and multi-party computation.

Input/Output Privacy

In order to achieve confidentiality, each compliance policy may include information about which inputs and outputs are confidential, i.e., specify the required inputs and side-effect outputs needed to conduct a transaction, as well as employing a confidentiality labeling schema that dictates the confidentiality requirements associated with each piece of input and output data. This labeling supports multiple gradations that range between “fully confidential” (in which case no data about the input/output will be available to other parties), to “fully public” (in which case the data will be fully available to any party who observes the transaction on the ledger.) Many intermediate gradations are supported as well. For example, policies may specify that a particular transaction input/output is visible only to specific parties, e.g., regulators or banks. Policies may also specify that a specific transaction input/output can be used to conduct aggregate statistical data collection. A more complete description of the confidentiality labeling schema is given in later sections.

While most inputs to the transaction policy are known by the wallet that generates the transaction, there are exceptions to this rule. For example, a policy may include a list of flagged addresses or conditions for generating a Suspicious Activity Report.

### Asset-Aware Services (AAS)

As discussed above, asset-aware services represent an exception to the compliance policies, where discretion is given to designated external parties, or to designated protocols and smart contracts, to accurately convey CRAI or enforce behavior.

### COMPLIANCE POLICIES—EXAMPLES

Examples of compliance policies are presented below. It will be appreciated that these are illustrative only, and the SAP is not limited thereby. It will be further appreciated that a single compliance policy may comprises elements of one or more examples given below, mutatis mutandis.

### Example #1: Regulatory Closure

According to some examples, a compliance policy simply ensures that all funds in a compliant pool remain associated with the pool as they transition between wallets, and to ensure that they cannot transfer to other pools (except where specifically allowed by the policy). A regulatory closure policy may be enforced by specifying a compliance policy that ensures several conditions. Each transaction must cryptographically bind an identifier for a specific compliant pool into the transaction contents, and each sealed wallet must also bind a pool identifier to any funds stored in the wallet. (Pool identifiers may comprise a cryptographic hash of the policy program or an identifier that is uniquely bound to a specific policy by the network. Such identifiers may be included within the transaction as a cleartext field, or they may be cryptographically bound to the transaction using various technical means described in later sections. Sealed wallets may be bound to multiple pool identifiers, provided that funds are segregated within the wallet to indicate which funds belong to each identifier.)

The policy itself will enforce the following conditions: (1) any transactions received by a sealed wallet must be associated with a specific pool identifier that is also contained within the wallet, (2) all funds held by the wallet must be associated with the pool identifier contained within the transaction that they were received in, (3) all transactions sent by the wallet must embed the pool identifier that they were associated with in the wallet. A further extension of this idea is to authorize only specific wallets to transact in certain pools; this may be accomplished, e.g., by binding the pool identifier(s) into the wallet's identity certificate, and requiring that the appropriate certificate be present in the sending and/or receiving wallet.

Occasionally, it may be necessary to permit funds in one compliant pool to transition into a different compliant pool, e.g., when funds transition between different regulatory jurisdictions. This may be authorized by making specific exceptions in the compliance policy to allow funds to transition between pools. However, such exceptions may not be known at the time a policy is developed, and they may be subject to specific restrictions that depend on context. These issues are addressed by authorizing gateways to allow funds transfers. In this case, the compliance policy can authorize gateways in two different ways: (1) in a custodial solution, each policy can specify an “allow-list” of specific senders that are allowed to bypass policy restrictions and change the pool identifier associated with outgoing funds. In this model, funds can be transitioned between pools by first sending them to a gateway, which the policy subsequently allows to send them onwards into a different pool. Alternatively, (2) in a non-custodial solution, a policy programs may require an additional policy input that comprises a bypass certificate, i.e., a cryptographic message signed by a gateway key identified in the policy. The bypass certificate may indicate that a specific allowed transaction may bypass the policy restrictions. An advantage of the second solution is that gateways do not gain custodial control over any funds.

### Example #2: Regulatory Escrow

Regulatory escrow systems store additional information within each transaction recorded on the ledger, encoded in a form that is readable only by specific parties. This information may include details about the transaction that is not available in readable form on the ledger (e.g., as is common when the ledger provides privacy features), or other information that is not normally included in the transaction, such as KYC identity information.

To support a regulatory escrow system requires that each transaction include a special data field which we refer to as the Regulatory Escrow Access Field (REAF). In practice, the REAF is an encrypted container that is decryptable only by a specific recipient or set of recipients that we call the regulatory escrow authorities. Non-limiting examples of appropriate escrow authorities include government regulatory agencies, third-party compliance firms, or banks.

For regulatory escrow to be meaningfully enforced, each transaction in the sealed pool must contain an attached or associated REAF that embeds correct and relevant information. The existence and correctness of the REAF is enforced by the compliance policy. More concretely, the compliance policy ensures that: (1) each transaction must contain a correctly-formatted REAF, (2) the REAF must represent a valid encryption under the keys of policy-specified regulatory escrow agents(s), and (3) the REAF must contain the appropriate collection of information for this transaction. The REAF itself can be constructed using a public-key encryption scheme that encrypts the relevant transaction data under the public key(s) of the appropriate escrow parties. The plaintext embedded within the REAF ciphertext may be specified by the compliance policy. This is supported by any compliance policy that meets our criteria above: namely, that it can reason over transaction-adjacent information (such as the REAF ciphertext attached to the transaction) and other transaction inputs. The contents and recipients of the REAF may be fixed by the policy, or the policy may dictate different information and recipients based on the nature of the specific transaction.

### Example #3: Sender and Recipient Deny-List

In some cases, regulators and banks may identify specific accounts that should be prevented from sending or receiving transactions, either temporarily or permanently. These accounts may be identified by specific cryptocurrency addresses or by specific transactor identities. In principle this list may be fixed as part of the compliance policy, but more commonly it will change from time to time.

Supporting this functionality requires several preconditions. First, an authorized party (or parties) must periodically determine the list of disallowed accounts. This list must then be published to transactors on the system in a form that includes cryptographic authentication, ensuring that all parties can verify the authenticity of the list and that it is “fresh,” i.e., that the given version of the list is the most current one. These properties can be achieved by publishing the list on a public ledger, or by publishing a cryptographic “digest” (hash) of the list on the ledger and transmitting the list itself through some separate channel.

Enforcement of the deny-list is ensured by specifying a compliance policy that reasons over both the current version of the deny-list and the inputs to a given transaction (e.g., sender and recipient account identity.) In the event that either the sender or recipient account is contained within the list, the compliance policy will disallow the transaction.

The above assumes that the full contents of the deny-list are available to the sender. In some cases, publishing this information may be undesirable. In later sections we address how some inputs to the compliance policy can be published in a form that is confidential to the sender.

### Example #4: Statistical Data Collection

Several applications require the availability of aggregate statistical data regarding transactions made within a compliant pool. This requires that transactions reveal some data about each transaction, such that no useful information about individual transactions is made available—and yet aggregate statistics about many transactions can be derived by a data aggregator that is authorized to compute data aggregation.

Data aggregation can be enabled using multiple underlying mathematical techniques, which we describe in detail later sections. Briefly, these can be summarized as follows: (1) transaction statistical data can be collected through the use of homomorphic encryption (encryption that allows mathematical operations to be conducted on encrypted data); (2) transaction statistical data can be collected through the use of noise-obfuscated summation techniques (such as the randomized response technique), in which statistical data is combined with statistical noise such that aggregate data can only be collected by summing large numbers of transactions and removing the noise; and (3) statistical data can be collected by encrypting relevant data under a key controlled by a trusted hardware component, e.g., an Intel SGX enclave that performs statistical aggregation without revealing individual transaction data. These techniques can be combined in various ways, as discussed in later sections.

The data needed to compute aggregate statistics may be published alongside each transaction in a specialized field called a Statistical Aggregation Field (SAF). The compliance policy enforces the presence and correct structure of a SAF on each authorized transaction, in a manner similar to the way a policy can enforce the presence of a REAF. The policy enforces that the SAF encodes some specific mathematical function of the relevant transaction data, where the exact nature of this function depends on the mathematical techniques used to perform statistical aggregation. The inputs to the function and the nature of the function itself may be fixed for all transactions, or the compliance policy may specify different structures (as well as different function inputs) for transactions with different characteristics. An advanced policy can also include programmatic logic that allows a centralized party to change the structure of the function by publishing new data to the transactors on a periodic basis. Through this mechanism, the operator's data platform can “tune” the quality and types of data collected.

Once SAFs are attached to each transaction, the data aggregator may calculate aggregate statistics about a transaction conducted over time by combining information from many SAFs issued during some time period. The nature of this aggregation depends on the mathematical technique used to construct each SAF, and the precision of the statistical aggregate may depend on the technique used and the number of transactions collected. This combined data may then be published to users via the data platform API and/or be published to transactors via data oracles.

### Example #5: Suspicious Activity Reporting

A number of regulatory frameworks require banks and financial institutions to analyze customer transactions and submit reports that identify possible criminal behavior. These are often referred to as “suspicious activity reports” (SARs). In current banking practice (e.g., regulations in the United States), SARs may be constructed based on manual analysis of transactions or they may be generated algorithmically by automated systems. The issuance of algorithmic SARs can be enforced by a compliance policy.

Enforcing SARs via compliance policy requires two preconditions. First, the compliance policy must embed programmatic logic that evaluates transaction inputs as well as (optionally) information about ambient conditions (e.g., aggregate statistics published to the network via data oracle). The logic must evaluate these inputs in order to determine whether a given transaction should result in a SAR, and if so, what the content of the SAR should be. Second, the compliance policy must enforce a means for reporting the SAR to the appropriate authority.

SAR reporting is enabled via the Regulatory Enforcement Access Field (REAF), which contains data that is addressed to one or more regulatory escrow agents. When SAR reporting is enabled by a compliance policy, the policy specifies that each transaction contains a REAF field, and that SAR information should be incorporated into the data contained within the REAF. The REAF may include, for example: wallets addresses, parties' identity information as associated with their wallets, device identifiers, IP addresses, information about related prior transactions, etc.

(It will be appreciated that the existence of a REAF field containing SAR data does not necessarily require that any other regulatory escrow data is collected within the field. SAR reporting may optionally be combined with other regulatory escrow functions using a single REAF, or the REAF field may contain only SAR data and no regulatory escrow data. Other combinations are possible as well: for example, a transaction may contain multiple REAF fields addressed to different regulatory escrow agents e.g., one containing SAR data and one containing regulatory escrow data.)

The REAF field can be decrypted by authorized regulatory escrow agents, who will be responsible for conveying SAR information to the appropriate authorities. The use of a SAR reporting policy requires that the REAF will include a data field that contains the output of any SAR reporting function embedded within the compliance policy. When no SAR report is triggered by a transaction, the data in this field can be omitted or left empty. When a SAR is triggered, the resulting report is specified by the policy logic, and will be included into the REAF. Because the REAF is encrypted to a specific regulatory escrow agent, unauthorized parties should be unable to determine whether a given transaction embeds a SAR report.

A key design choice in developing a suspicious activity reporting system is whether the transaction sender should be aware of whether a SAR is triggered by a specific transaction. In many traditional banking contexts, both the SAR policy and knowledge of whether a SAR has been initiated may be kept secret from the customer as a means to prevent SAR avoidance. A compliance policy can address this by specifying the parameters to the compliance policy as confidential inputs that are not available to the transaction creator and/or receiver. The transaction sender and/or receiver will therefore be unaware of the inputs to the SAR, or whether a SAR has been created in response to a transaction. The technical means for implementing to confidential policy inputs are discussed in sections further below.

The policy may specify various conditions for automated issuance of SARs, including for example:
1) Customer identification (e.g., KYC data) anomalies, such as inadequate documentation, inconsistencies, multiple accounts.
2) Abnormally high transaction value, whether within a single transaction or over multiple transactions (e.g., “structuring” in attempt to evade detection), compared to either a fixed threshold designated by the policy, a dynamic threshold determined by a party thus authorized by the policy, or a dynamic threshold determined mathematically from other parameters (e.g., total trading volume in the given asset).
3) Transaction activity not commensurate with customer's character or income (e.g., as ascertained during the KYC process associated with their wallet), or abnormal compared to their past activity (e.g., heavy activity in a previously dormant account).
4) The account is flagged as suspicious or high-risk by some rules imposed by the policy, by the discretion of the Identity Provider, or by lists, alerts or criteria imposed by policy-prescribed parties (e.g., “Politically Exposed Person,” geographic regions, or sanction lists, or case-specific court orders).
5) Activity associated with to accounts or digital identities on other platforms related the wallet's owner, such as social network usernames, customer accounts at private companies (including financial institutions), employee databases, self-sovereign identity networks (blockchain-based or otherwise), Internet domain names ownership, etc. This may be done directly, or indirectly through identity-linking services such as Keybase.
6) Any other criteria prescribed by countries, states, international organizations such as Financial Action Task Force, or private organizations, for issuance of reports such as Suspicious Activity Reports and Cash Transaction Reports.

### Example #6: Exchange Asset-Aware Service

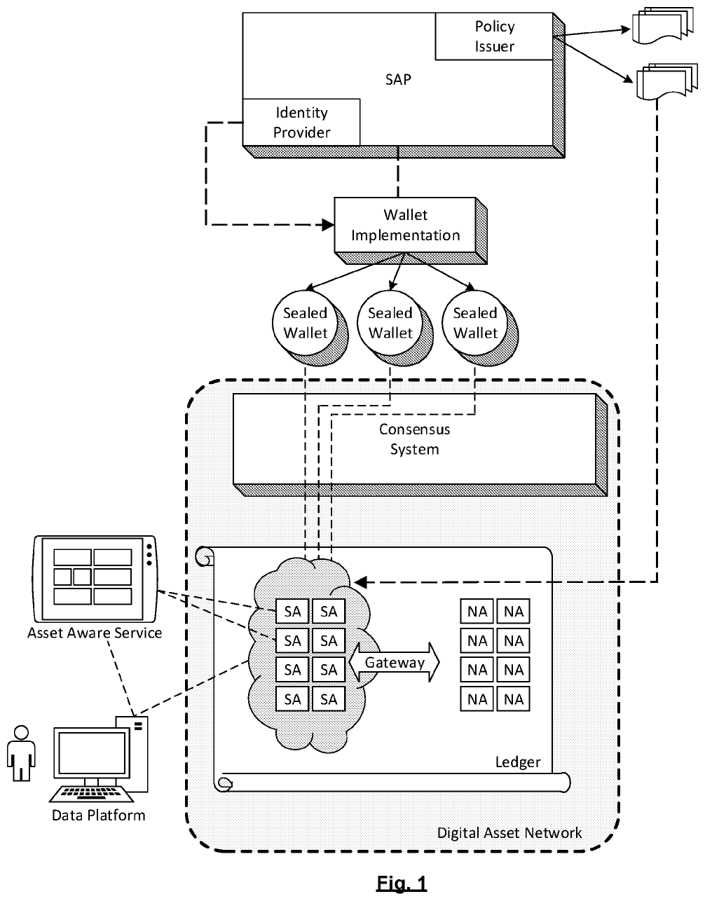

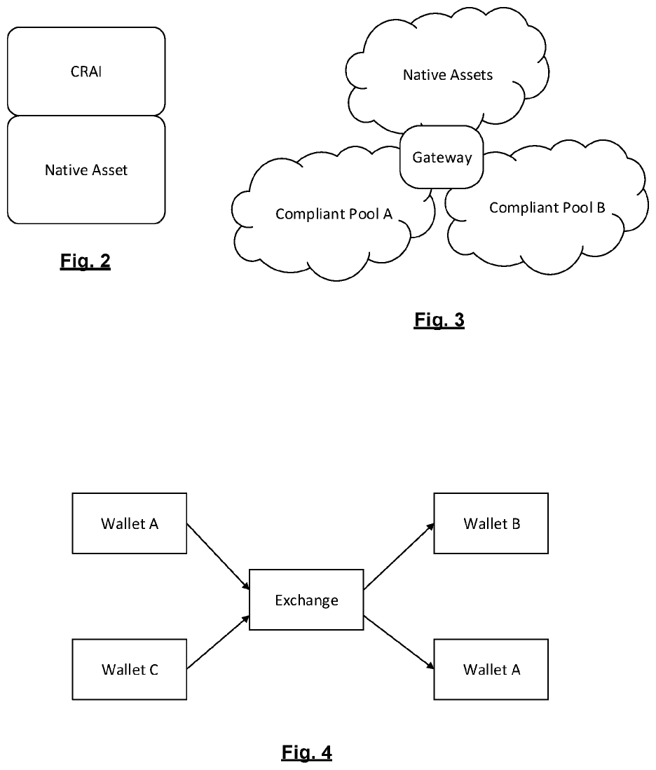

Exchange services, which let users trade one asset for another, may require special treatment in order for such trades to meaningfully track the provenance of assets. Consider the case where the owner of Wallet A uses the exchange to trade Asset X for Asset Y, for example as illustrated in FIG. 4.

Technically, Asset X sent by Wallet A ends up in some other user's wallet, Wallet B. Likewise, the Asset Y received by Wallet A originates in some other user wallet, Wallet C. I tracking of CRAI would focus on this provenance. However, for a high-volume exchange, Wallet B and Wallet C are coincidental and irrelevant. Rather, the CRAI should convey the trade of Asset X for Asset Y by Wallet A, across assets by preserving the identity and past transaction history.

The compliance policy may would reflect the above. However, it cannot in general directly specify the mechanics of correctly tracking trades, since the mechanics of a trades are specific to each exchange's implementation. Thus, the compliance policy would authorize the exchange as an asset-aware service, that can provide this tracking by its own.

For a centralized exchange, this may for example be implemented as the compliance policy allowing the exchange AAS to determine the pertinent CRAI in exchange withdrawal transactions, reflecting correctly tracked trades. The correct tracking of trades would be done internally by the exchange, technically at its discretion, but backed by regulatory or contractual obligations for accuracy.

Some exchanges may be implemented via decentralized mechanisms that realize trading order books or autonomous trading algorithms, such as automated market markers (AMMs). In this case, there may not be a legal party to bind for correct behavior. Thus, the AAS may instead be mechanized, ad realized as a specific protocol (implemented as a smart contract and supporting software) that tracks trades in a provably rigorous way. The smart contract may operate in the clear, where anyone can observe trades and verify correctness of the CRAI. Alternatively, it may use privacy-preserving cryptographic mechanisms, such as zero-knowledge proofs, to enable the user performing the trade and prove that their own CRAI is correctly updated, without explicitly revealing this CRAI to anyone (except those authorized under the compliance policy).

In cases where the exchange operation comprises auxiliary assets, such as liquidity provider tokens for an AMM, these auxiliary assets too may be tracked by the AAS and instructions thereon may be specified by the policy. For example, when a party deposits assets with an AMM and obtains liquidity provider tokens in return, the AMM—operating as an AAS—may augment the liquidity provider tokens with the depositor's CRAI, such as identity and/or fund provenance (as conveyed by the deposited assets and the depositor's sealed wallet).

### Example #7: Risk Management

Policies and SAP may be used to facilitate the implementation of a risk-based approach and the enforcement of risk tolerance policy by regulated entities and other financial organizations. In some existing systems, entities such as financial institutions require a score rating based on a user's activity on the blockchain. This “risk score” or “risk profile” represents a best estimate of the likelihood that a user or a user's funds have been involved in non-compliant activity. Different entities may assign higher or lower risk scores to the same transaction or user depending on a variety of factors. Such risk scores or profiles may be used by VASPs and regulated entities in order to manage and/or mitigate their exposure to risk, and may be updated from time to time based on a variety of indicators. Such risk management practices can be accomplished in a manner similar to the aggregate statistics example above, or with the set of statistics to be computed limited to an individual user. Calculation of risk may be based on, e.g., the risk tolerance policy, information collected, etc.

### Example #8: Organizational Auditing

An organization (including an individual) may impose a policy on the wallets it owns (e.g., company assets and employees' business-expense wallets), which facilitates auditing functions. This organizational policy would complement and augment the compliance policy imposed by the jurisdiction(s) to which the organization is subject. The auditing may, for example, keep track of aggregate statistics on fund flows and make them visible to designated parties. It may make visible to designated parties, in real time, transactions that are anomalous or high-risk by some criteria, for example being analogous to the Suspicious Activity Reporting disclosed above, but at the organizational level, mutatis mutandis. It may also reason over total account balances, and either block, issue alerts, or require manual approvals if these exceed some criteria (e.g., a reserve account, or a discretionary-funds account, falls below a threshold).

Furthermore, audited properties of the organization's sealed assets may be cryptographically certified for presentation to third parties, using cryptographic proofs that rigorously convince the third parties of a claim's correctness. Such attestations may include, for example, proofs that balances are above some threshold and have been so for some duration, proofs of net asset inflows; or proofs that account holdings match some liabilities (whether with or without revealing the amount of those liabilities).

### Example #9: Redundant Checks

A policy may include multiple redundant checks. For example, the policy may specify a complicated cap or reporting criteria, to be mechanically enforced by privacy-preserving protocols that perform the requisite accounting. The policy may then moreover specify that the pertinent information is also revealed to a designated auditor, who can double-check the calculation and ensure that the mechanical enforcement did not fail. This auditor may be legally bound to maintain secrecy, and may be invoked only if erroneous operation is suspected (e.g., at the discretion of the organization's management or the courts), yet its presence provides extra safety and enables recovery from technical failures.

### Example #10: Chargebacks and Fund Recovery

A policy may dictate that certain transactions are not irrevocably finalized until some criteria, such as passage of certain time, is satisfied. The policy may moreover designate criteria under which transactions can be actively reversed and the virtual assets returned to the sender fully or partially when the circumstances of the transaction meet the requirements of a chargeback policy (i.e., a “chargeback”). This can be used to verify authorization of the transaction by the owner; to handle a dispute in the transition; to facilitate returns of merchandize; to enforce purchase controls and facilitate potential transaction cancellations; to mitigate fraud; to refund theft, loss, damages, and errors; and to detect questionable merchant activity, for transactions facilitated on a blockchain (including by a “cyber-attack” that technically compromises the wallets security, or by malicious human action). By allowing for chargebacks, the risk of harm from theft may be mitigated, thereby providing a potential disincentive for committing the crime in the first place.

### Example #11: Tax Payments

A policy may dictate that payments made to certain wallet(s) must be accompanied by other, commensurate payments. For example, any payment to a retail merchant wallet may be required to be accompanied by a VAT payment to the pertinent tax authorities. The policy would specify the computation of the accompanying payment, and its destination, and to which wallet the policy applies. This policy may be imposed by the jurisdiction, or it may be voluntarily self-imposed by the merchant as a means to assure its own compliance with relevant tax laws, regulations, etc.

A policy may also include tracking of CRAI that is relevant to compliance with tax regulations. For example, capital gain tax typically requires knowing the tax basis (cost of acquisition) of each asset disposed of. At present, this basis computation is not done by existing distributed ledgers; instead, taxpayers need to track their tax basis by themselves or by depending on third-party services. Our system would let tax basis be included as CRAI that is inherently attached to transactions. This enables higher reliability and interoperability. Moreover, it can handle more nuanced concepts. For example, US federal tax regulations allow for specific identification of tax lots, wherein the party disposing of an asset can contemporarily designate which of multiple similar assets, with different tax bases, is the one being disposed of. The policy may add this identified tax lot and corresponding basis within the CRAI. Our system may then provide certification as to the amount of gain consequently generated by the transactions. The system can enforce requirements such as the specific lot identification being done contemporarily with the disposal transaction, and correct accounting for tax lots (e.g., the same tax lot cannot be reported as sold more than once). The policy may even enforce then payment of this tax to the tax authorities, for example as described above. The policy may also include computation of the applicable tax rates, for example by keeping track of the holding period of the asset in the associated CRAI, and by deducing whether long-term or short-term capital gains tax rates are applicable.

### Example #12: Management of Decentralized Applications

The consensus systems may host one or more decentralized finance (DeFi) applications. These applications are generally implemented using smart contract programs that run directly on the consensus system and enable payments and other functionality, although some DeFi systems also incorporate more centralized components such as pricing oracles and exchange order matching systems. Unlike centralized systems, DeFi applications are not run by a centralized party and may not be able to store secret keys. Hence, they cannot store any secret component of an identity certificate. Because the operation of these decentralized systems is generally transparent, meaning that all parties can see the inputs and outputs that they process, users who interact with DeFi applications may be responsible for generating CRAI for outgoing transactions sent to DeFi services, and re-constructing the necessary CRAI on later transactions to show the complete history of funds traveling through a DeFi application. In this case the policy would require the user to keep track of the transaction history pertaining to their interaction with a DeFi application, and the system would enforce the integrity and correct deduction from this transaction history.

### Example #13: Foreign Account Reporting

A policy may enforce compliance with foreign account reporting requirements, such the US Foreign Account Tax Compliance Act (FATCA), or the OECD's Common Reporting Standard (CRS). If a sealed wallet is deemed, e.g., by a jurisdiction, to contain digital assets representing a foreign account subject to mandatory reporting requirements, the policy may include identification of such wallets (e.g., as provided by the wallet identity provider who provides the identity certificates to the sealed wallet). The policy may mandate, for such wallets, the issuance of one or more reports, e.g., as defined by the jurisdiction, relating to wallet ownership, identifiers (e.g., tax identification numbers), balances, and/or any other required information. The reports may be issued automatically using a REAF field, for example as described above in the context of SARs. The reports may also be issued periodically by the sealed wallets. Accuracy of these reports, including calculated contents such as maximum annual balances, may be enforced by cryptographic means such as zero-knowledge proofs attesting that the reported output was correctly computed from the underlying transactions and CRAI. The policy may also integrate into these reports additional information obtained from AASs or external due diligence procedures.

### Example #14: Blocking and Sanction Enforcement

A policy may specify that some transactions are forbidden and blocked. This may be realized by a computational decision procedure that inspects a tentative transaction and reports whether that transaction is permissible. The decision procedure may reason over information that is visible in plain text within the transaction data. The decision procedure may further reason over CRAI that is not visible in plain text within the transaction data, but whose existence and integrity are assured by cryptographic means.

For example, the policy may specify a block list or a sanction list, comprising of a set of countries, and specify a rule that transactions are forbidden if the sender or recipient's nationality are within such a list. Nationality may be specified within the identity certificate attached to sealed wallets. Thus, any transaction in which either party's identity certificate specified a nationality within the list will be detected as forbidden by the decision procedure.

In this example, the nationality may be included in private CRAI that is attached to the sealed wallet but not publicly revealed. Nonetheless, the policy may still be enforced by cryptographic means, such as zero-knowledge proofs (for example as discussed below) that may be generated by the sender, attached to the transaction, and verified by the decision procedure.

Policies may also specify blocking based on identity attributes such as names, or national identifying numbers, based on transaction history, based on associated account numbers, or based on any other data in the CRAI, oracles, or other information sources available within the system.

The parties that extend the ledger with new records (e.g., miners or validators) may invoke the decision procedure, and refuse to include forbidden transactions in the ledger.

Even if forbidden transactions appear within the ledger (e.g., because the miners of validators failed to perform and act on the decision procedure), any other party may perform the decision procedure to recognize forbidden transactions, and then refuse to recognize these as valid. Consequently, the system described herein may operate as an overlay on top of an existing consensus system whose miners or validators are not cognizant of the system's transaction-checking rules.

The decision procedure may comprise a delay element that makes the decision outcome visible only after some time has elapsed or some parties have taken an action. This may prevent transaction sender's from knowing in advance whether their transactions match the sanction rules, and thus facilitate detection of attempts to circumvent sanctions or reverse-engineer sender-opaque policies (see below).

### Example #15: Lending Asset-Aware Service

Lending services, which let users lend or borrow assets (and often, earn or pay interest on such loans) may require special treatment in order to meaningfully track the provenance of assets. As described above with reference to Example #6 (Exchange asset-aware service), naively following asset flows may lead to incorrect tracking of fund provenance. For example, when a loan is made by a lender to the lending service, followed by a loan from the lending service to a borrower, native tracking may show the lender's assets being transferred to the borrower. Likewise, when a lender recalls a lInaive tracking may attribute the funds to a transfer from some other lender who happened to have a made a recent loan to the lending service, or to an arbitrary borrower who recently returned their loan. However, more meaningful attribution of fund provenance would be to express the returned loan assets as carrying the CRAI (identity, provenance, etc.) of the original loan assets.

A policy may allow the lending service to be an asset-aware service, which provides the latter attribution of funds provenance. This may be realized by reliance on the operator of the asset-aware service, or in a decentralized fashion using communication protocols and cryptography, for example as described above with reference to AASs.

The AAS may additionally track provenance across asset types, such as when one asset type is lent but another asset type is returned in settlement of the loan, for example as described above with reference to Example #6. The AAS may also propagate CRAI and track provenance for loan collaterals, hypothecation, and/or hypothecation.

### Example #16: Protecting Assets from Theft or Coercion

Asset owners may choose to impose a policy on their own wallets and assets, for example to protect themselves from loss of these assets through theft or coercion.

According to some examples, a policy may restrict the movement of funds by blocking outbound transfer unless extra verification criteria are satisfied. Such criteria may include, but are not limited to, approval, authentication or identity verification performed by additional means or parties, and/or a time window during which the transaction remains pending and may be cancelled by the sender.

According to other examples, the policy may restrict the destinations to which the funds may be sent, e.g., using an allow-list or a block-list mechanism, similar to that described above with reference to Example #14 (Blocking and sanction enforcement), except that the lists may be set by the asset owner.

According to further examples, the policy may issue alerts, visible to the asset owner or other their authorized parties, for transactions in these wallets and assets, similar to that described above with reference to Example #5 (Suspicious activity reporting), except that the alert's recipient differs.

It will be appreciated that some or all of the above examples may be combined. For example, the policy may specify such restrictions or blocking as applicable to all assets and/or wallets of a certain party or group thereof; or it may specify criteria for activating restrictions and reporting, such as transaction amounts thresholds or any other criteria that can be evaluated on transaction patterns and CRAI.

### Example #17: Organizational Policy

Organizations dealing with virtual assets may impose policies on their own wallets and assets, in order to protect these from theft or coercion, similar to that described above with reference to Example #16 (Protecting assets from theft or coercion), and/or also to track fraud, embezzlement, and other misconduct. Example described above with reference to Example #16 are likewise applicable. The organizational policy may be written and deployed by the organization's authorized financial officers. It may specify organizational officers are authorized to approve restricted transactions. It may specify organizational officers as the recipients of reports mandated by the policy. The policy may apply to transactions within the organizations, and/or may apply to transactions between the organizations and its counterparties such as customers, suppliers, financiers, etc.

Data Platform

The data platform comprises a system for collecting aggregate data from transactions conducted on the ledger and within AASs, and presenting this data for viewing by customers, as well as for use as input to compliance policies. The data platform employs privacy-preserving techniques to ensure that minimal information about individual transactions is revealed to unauthorized parties, while still allowing for the collection of aggregate statistics.

Data Oracles

A data oracle is a system designed to publish data to participants in a cryptographically authenticated fashion, for example as is well-known in the art. Such data can be used by decentralized systems, including transaction initiators as an input to a compliance policy when generating new transactions.

Writing/Deployment of Policies

A compliance policy represents an algorithm or logical circuit that defines a calculation and (implicitly) a mathematical relationship between certain transaction inputs and outputs. (Owing to the equivalence between algorithms and logical circuits, the terms and terms related thereto will be used interchangeably herein.) Policies may be coded in a human-readable policy programming language, which are compiled into lower-level formats that are directly consumed by the policy enforcement mechanisms. Specific input and output variables to the policy programs may be marked with a confidentiality labeling schema, which specifies which inputs and outputs should be visible and to whom. For each policy represented this way, the confidentiality markup information may be included as part of the policy program or it may be written in a separate file. Policy programs can be written in a number of possible languages, some of which already exist, or they may be written using a specialized “domain specific language” designed for this purpose.

Some input and output variables will also be explicitly reserved as being related to a transaction's data and/or data stored within a sealed wallet. For example, a program might have an input variable that represents the amount of funds sent within a transaction, the recipient address of a transaction, or fields from the identity certificate located within the sealed wallet. Similarly, input variables may refer to auxiliary data values that are associated with the transaction or associated wallets, in their corresponding CRAI. Variable values may be given directly by a process or party (e.g., transaction amounts); may be computed by the system from other values (e.g., summations of past transaction amounts); may be provided by the policy or policy-designated data sources; may be randomly drawn numbers; may be generated by “data oracles” as discussed above; or may be produced by any other process.

Each program includes at least one required output: namely, 35erify351e boolean (true/false) result that indicates whether the policy requirements are satisfied, and hence a transaction should be allowed by the network. This result can be output explicitly, although it may be implicitly defined by the programming language. For example, programs may produce an error message when conditions are not satisfied. A program may also specify zero or more additional explicit output values. Alternatively, the program may be represented in the form of a logical predicate (e.g., a conjunction of constraints), with the convention that the output is “true” if the logical predicate (e.g., all constraints) are satisfied.

Once written by programmers, policies will typically be compiled by a compiler toolchain into a form that can be evaluated and reasoned over by the components of this system. Thus, developers can use multiple distinct high-level programming languages for policy development, and the compiled output of each language will be in a shared representation that is compatible with our system.

To take effect, policies are deployed to parties that require knowledge of the policy, which may include sealed wallets, AASs, data platform, miners, validators, etc. Such deployment may be done by various means, including publication of the policy on the public ledger, via Internet services designated by resource locators such as host names and URLs, or via data storage services (whether centralized or decentralized). Policies may also be bundled together with the software that uses them. For example, a sealed wallet application may be distributed in a package (e.g., an APK or ZIP file) that contains a copy of the policy. Policies may be distributed in source or compiled form.

A policy may require authentication in order to ascertain that it has been issued by the intended party (e.g., a regulator or a consortium). Such authentication may be done by means of cryptographic digital signatures on the policy itself, indirectly by authentication of the digital channel by which the signatures are retrieved (e.g., an HTTPS URL via which a server presents a digital certificate and digital signature), or by any other trustworthy channels. Authentication may require approval by multiple parties, which may be realized by cryptographically realized by multiple digital signatures, by aggregate signatures, or by threshold signatures.

Policies may be imposed by an individual or organization on themselves (i.e., some or all of the wallets and assets that they control or own), for example as described above with reference to Example #16 (Protecting assets from theft or coercion) and Example #17 (Organizational policy).

Policies may be updated or revoked, either in whole or in part (e.g., components such as allow-lists and block-lists). Such updates or revocations may likewise be distributed and authenticated by any of the above means.

Policies deployments, updates and revocations may be publicly visible. They may also be fully or partially opaque, as when implementing sender-opaque policies (for example as described below).

Policies deployments, updates, and/or revocations may include the description of the policy changes, along with additional data required for realization of these policies. For example, for a policy which is realized by a zero-knowledge proof (see below) that utilizes a common reference string (also known as structured reference string, public parameters, or trusted setup parameters), the requisite common reference string may be included in the deployment or update. Alternatively, this data may be provided indirectly, for example by providing an Internet resource locator.

Enforcement of Policies

Once written and compiled, policies are enforced by the system using multiple underlying mechanisms. These may include cryptographic mechanisms such as zero-knowledge proofs (interactive or non-interactive), secure multiparty computational protocols (whether interactive or non-interactive, for two or more parties), encryption and homomorphic encryption mechanisms, and program obfuscation algorithms. The choice of implementation mechanisms employed will depend on the content of the policy.

Prior to engaging in transactions, each sealed wallet must first be provisioned with a wallet implementation (embodied in software and possibly hardware, as discussed above) to correctly formulate transactions and CRAI.

The consensus system itself may also be provisioned with logical systems that allow network operators to validate the correct formulation of transactions and CRAI. In some cases, this may be constructed using existing flexibility in public ledger systems, such as the “smart contract” mechanisms in the Ethereum blockchain. It may also be done using extensions to existing or new platforms, e.g., via the use of “precompiles” (dedicated instructions in the Ethereum smart contract bytecode language) that allow for the verification of specific zero-knowledge proof systems. Alternatively, new systems may be added to the consensus system in order to support validation. Alternatively, validation may be done separately from the underlying distributed ledger and its consensus policy, i.e., some transactions will be included in the underlying ledger, but fail validation when checked by our system and thus deemed non-compliant and excluded from the compliant pool.

Prior to submitting a transaction into the system, the sealed wallet component must receive the required compliance policy in a machine-readable form. This form may consist of a representation in a high-level programming language and/or a low-level “bytecode” (e.g., low-level instruction language that is designed to be executed by software components called virtual machines) or circuit representation of the policy algorithm. These policies may be received directly from the consensus system ledger, or from some out-of-band location. The transaction sender will then construct the transaction data using the formatting steps required by the consensus system. It will then construct the attached CRAI components as described below.

Compliance policies can be broadly classified into two categories:
Sender-transparent policies include those policies in which all compliance policy input values are known by the sender at the time of transaction construction.
Sender-opaque policies (fully or partially) include those policies in which some program input values may be unknown to the sender. This occurs because the necessary inputs are either chosen by the transaction recipient, or because they are chosen by some other component of the network such as the compliance policy author (or designated parties to which they delegated this authority).

Sender-Transparent Policies and Blockchain Integration

We first consider the case where all necessary policy input values are known to the sender. In this case, to construct the CRAI, the sender wallet component will first evaluate the compliance policy on the known inputs. Evaluating the policy requires the sending wallet component to calculate the algorithmic steps of the policy program or circuit to compute the outputs of the program. This calculation may take place inside of a virtual machine, which is a specialized software component designed for executing programs. Some input variables may be specified by the policy as representing transaction-specific data (e.g., amount or transaction recipient), data held by the sealed wallet, data computed from other values, data provided by the policy or policy-designated data sources, randomly drawn numbers; etc.; the system executing the virtual machine must ensure that the corresponding data values are indeed used. At the conclusion of this process the sender wallet component will obtain the program outputs and/or any intermediate data calculated during the course of executing the compliance program.

If the policy evaluation indicates a successful result, then the transaction has satisfied the compliance policy and hence the transaction and any policy program outputs can be bound together and transmitted to the consensus system for inclusion on the ledger.

However, the consensus system systems may not trust that the sealed wallet has correctly evaluated the policy. Moreover, because some inputs to the policy are confidential (and hence the sender wallet will not reveal those values to the network), the consensus system may not be able to verify the correctness of the policy program itself. To resolve this impasse, the sender wallet component will generate a zero-knowledge proof that it has correctly evaluated the program and attach this proof to the transaction.

A “non-interactive zero-knowledge (ZK) proof system” is a well-known cryptographic technology that comprises two logical components: a prover and a verifier. The prover takes as input some secret data, known as a “witness” along with a “statement” which is a description of some mathematical relationship within the given data. (Often, the statement is further separated into an “instance” which is non-secret data, and a “relation” which is a description of some mathematical relation involving both the witness and instance). If this mathematical relationship holds, then the prover can generate a “ZK proof” which itself is a data object. The verifier component takes as input the ZK proof, as well as the statement, and determines whether the proof is valid. If the verifier determines that a given proof is valid, this indicates with overwhelming probability that the prover did indeed know a correct secret input that satisfies the statement. In the context of a computer program, the inputs and outputs of the computer program may be considered as data and the program itself may be treated as a mathematical relationship defining the statement. As noted above, policy programs can be treated equivalently to a mathematical relationship between program input and output data, hence ZK proofs can be used to prove that the outputs of a computer program are correct given some inputs, even when portions of the input data are withheld from the verifier.

In particular, our system may utilize zero-knowledge non-interactive arguments of knowledge (zk-SNARK), which are a form of non-interactive zero-knowledge proof systems with additional efficiency and security properties. Our system may also utilize “interactive zero-knowledge proof system,” which has similar properties, except that the proof is not a data object, but rather an interactive protocol carried out by the prover and verifier.

To author a transaction, the wallet component used by the transaction sender will incorporate a prover component for an appropriate zero-knowledge proof system. Once the policy program has been evaluated, the prover will construct a proof that the outputs of the program are correct and that the transaction itself is correctly formulated. The wallet program will then combine the transaction with any non-secret program inputs and outputs, and the zero-knowledge proof. (In some cases, the non-secret inputs and outputs will already be known to, or may be calculated by transaction verifiers. In this case, those inputs need not be explicitly attached to the transaction provided that the transaction verifiers know where to obtain the necessary data.) This additional data attached to the transaction comprises the CRAI. The CRAI-augmented transaction data is then transmitted to the ledger network, where one or more transaction validator components will incorporate the verifier component of the zero-knowledge proof system. The validator(s) will verify the transaction data according to the rules specified by the underlying consensus system, and will also verify that the zero-knowledge proof is valid. The transaction will be accepted as a valid sealed transaction if both verification procedures indicate success. Inclusion of the transaction in the ledger network may or may not be conditional upon the validity of the zero-knowledge proof.

It will be appreciated that in some cases it may not be possible to utilize or alter the underlying consensus systems (e.g., Bitcoin) to validate zero-knowledge proofs and/or other PAS transaction verification rules using that consensus system's rules. In this case, CRAI can be attached to transactions and validated by separate validator components and/or transaction recipients themselves. The PAS may thus be configured to allow the CRAI-augmented transaction data to be checked by new validators, called overlay validators, which may be distinct from those of the underlying consensus system. Parties that use the PAS will rely on overlay validators and/or carry out their own validation to recognize transactions that are valid for the PAS in addition to being part of the underlying consensus system's state, and are thus within the compliant pool of transactions. Any transaction which appears in the underlying consensus system's state but does not pass verification of the PAS rules, may be handled as follows: if it does not involve any sealed assets, then it is irrelevant to the PAS. If it does involve sealed assets, then policy-determined actions will be taken. For example, this may be deemed “breaking the seal” of the assets by the sender (for example as described above).

Some consensus systems may be configured to store CRAI within transactions in a structured manner that can be accessed by validators of the underlying consensus layer. Other consensus systems may be configured to store CRAI only as opaque data, to be reasoned over by overlay validators (e.g., OP_RETURN data in the Bitcoin blockchain). Other consensus systems may be unable to store CRAI with the transactions, or may impose excessive costs to do so; accordingly, transaction-associated CRAI may be stored in an alternative location that references the actual transactions or vice versa. A skilled artisan will recognize that each of these alternatives offers similar properties to the preferred embodiment in which CRAI is validated by the consensus system and incorporated directly into the consensus system ledger.

It should be noted that some existing consensus systems include provisions to verify zero-knowledge proofs as part of the consensus system transaction rules. For example, Ethereum includes a “smart contract” capability that is verified by an Ethereum Virtual Machine (EVM). One operation that is currently supported by the EVM is a ZK verification operation for certain ZK proof systems, which ensures that a given zero-knowledge proof is valid. In a preferred embodiment, zero-knowledge proof validation will occur using capabilities that are native to the consensus system. Where necessary, this capability may be added or performed outside of the network.

Sender-Opaque Policies

In some cases, policy programs must reason over selected inputs that are not available to the sender wallet that generates the transaction. Non-liming examples of such policy programs include those that generate Suspicious Activity Reports (SARs), where it may be undesirable for authorities to reveal the exact conditions for generating a SAR; and similarly for lists of sanctioned parties or other criteria. Similarly, policies may reason over inputs that are known to the transaction recipient rather than the sender. This might include confidential details of the receiver's identity certificate.

When some inputs to a policy program are unknown to the sender, we refer to these policies as fully or partially “sender opaque.” A consequence of such policies is that, when the inputs to the program are not known to the sender, then the sender cannot easily evaluate the policy and compute the program outputs. Thus, the sender cannot compute a zero-knowledge proof over such inputs and outputs, as required by the previous approach.

To evaluate such policies, our system may make use of a cryptographic system known as a non-interactive two-party computation (NI-2PC) system.

Two party computation (2PC) is a technique that allows two components, a Generator and an Evaluator, to evaluate some program or circuit while preserving confidentiality guarantees. Specifically, in 2PC each party provides some pre-agreed subset of the program inputs, and each party receives some pre-agreed subset of the program outputs. A critical security property of these systems is that the parties will each learn only the appropriate portion of the program outputs, and will learn no information about the other party's input, or even any intermediate values developed in the course of evaluating the program. 2PC is ordinarily conducted as an interactive process wherein the two parties exchange many data messages for each calculation. However, a specialized variant, non-interactive 2PC allows the Evaluator to commit to a specific data values for a subset of the input variables by broadcasting a single message. Subsequently, a Generator party B can select its own values for the remaining input variables and transmit a second message back to the Evaluator. Most critically, the message broadcast by the Evaluator does not reveal the Evaluator's inputs, and the message transmitted by the Generator does not reveal the Generator's inputs. At the conclusion of the process, the Evaluator learns only the appropriate output values of the program. An important benefit of the NI-2PC system is that the Evaluator need only broadcast a message at any point where it wishes to change its input values. However, the Generator party (or even many different parties acting as the Generator) can perform the second step repeatedly while specifying different input values each time. This allows the two parties to evaluate the computer program many times on different inputs provided by the Generator(s).

According to the presently disclosed subject matter, NI-2PC may be utilized to realize sender-opaque policy programs. To realize such a policy, some party, for example a policy author wishing to enforce a SAR, will operate the Evaluator. This party will select some secret inputs to the policy program, and will then broadcast the Evaluator's message to all parties that wish to use the policy. (It will be appreciated that the term “broadcast” refers to delivering the message to all parties. If the Evaluator's inputs are unlikely to change, this may be accomplished by distributing them along with the policy program, e.g., by writing it to the ledger. However other mechanisms for distribution can be used as well.) Each sender's wallet will incorporate the Generator component of the NI-2PC system. It will receive the first message produced by the Evaluator as well as the policy program along with any policy program inputs known to the Sender. It will output a second message that will be attached to the transaction as part of the CRAI, and/or to any other suitable location. To ensure that this second message is correctly formulated, the sender may attach a zero-knowledge proof showing correct formulation, using the same approach described in the previous section. Finally, the original party can use the Evaluator to compute the program outputs, or it can delegate this procedure to a third party by giving that party the necessary information to conduct the evaluation.

In some instances a policy program will be partially sender-opaque, meaning that some policy outputs can be computed using inputs that are all fully known to the sender, while other policy outputs cannot. In these instances it may be desirable to partition the policy program into two subprograms: a first sub-program that is fully sender-transparent, i.e., uses inputs entirely known to the sender, and a second sub-program that is sender-opaque, i.e., uses some inputs unknown to the sender. In this case, each transaction sender would need to satisfy both policies simultaneously. This would require the sender to use both of the systems described above for such a transaction. The process of partitioning the original policy program into subprograms can be conducted automatically using standard program analysis techniques.

Verifiable Encryption

In some cases it is desirable for a policy program to output some auxiliary data that is unreadable by the general public, but that may be readable by a chosen party or parties. An example of this situation is contained within the “regulatory escrow” policy example described earlier in this document.

This capability can be supported by incorporating specific operations into the policy programs, without further changes to the system described above. Specifically, policy programs can be specified that use public key encryption to produce outputs that are encrypted under the key of chosen parties. More concretely: in such policies, the policy will identify the following: (1) how to compute the plaintext data that is to be encrypted, (2) the public key(s) of the recipients, and (3) optionally some random bits provided by the transaction generator. The policy program will then incorporate logic that specifies the encryption procedure and produces a ciphertext as output. (According to some examples, the ciphertext may be used as an input.) As for other output, the ciphertext itself will then be attached to the transaction as CRAI, and the zero-knowledge proof will ensure that the data contained within that ciphertext is correctly formed. However, only the parties with the appropriate secret key to decrypt this ciphertext will be able to recover the encrypted data. To all other parties observing the ledger, this data will be inaccessible.

To support this capability for policy program developers, the policy development system can incorporate public-key encryption capabilities as a “library module” or “precompile,” i.e., a pre-written software component that policy developers can use to write policy programs. The policy program can also support the use of verifiable encryption implicitly. For example, the confidentiality markup schema may allow a developer to specify that a given output is available only to specific parties, and the system will automatically realize this policy by using the verifiable encryption system described above.

State and Past Blockchain Transactions

In many cases it may be desirable for policy programs to reason over information derived from past transactions, or possibly information derived from a collection of past policies. This problem can be realized by recording “state” information as an encrypted or “committed” output of the policy program, and attaching this data to each transaction. Later transactions can reference previous transactions on the ledger as non-secret data, and use this state information as an input. This reference is facilitated by ledgers that natively incorporate hash trees over the data in the ledger, such as Ethereum. Such trees can be used to construct efficient proofs that a transaction is in the ledger. A policy program can take such a proof as input, verify that it is correct, and then reason over the transaction data.

Statistical Data Collection

Some of the examples of compliance policies listed above specify that statistical aggregates may be computed from individual transaction data, in a way that does not reveal individual transaction details. A variety of techniques can be used to collect such aggregate statistical data about transactions in a privacy-preserving manner. Here we briefly outline several different techniques that can be used by different policy programs, and how they will be used in this system.

One approach to collecting statistical data is to delegate the statistical aggregation to a component that is allowed to see individual transaction data and can then compute statistical aggregates from it. To ensure the privacy of individual transaction data, this party must be trusted not to reveal it. Such trust may be achieved through legal or policy means, or through technical means. We refer to this party as the Aggregator.

Once such a party has been identified, individual transactions may submit relevant transaction data to this party by using the Verifiable Encryption technique described above in order to compute a Statistical Aggregation Field (SAF) that contains encrypted data. Each transaction will then contain such a SAF embedding a ciphertext containing the relevant data, and encrypted under the key of the Aggregator. The Aggregator will possess the corresponding secret key, and will receive transaction data. It can then decrypt each transaction to obtain the raw transaction data, upon which it will compute aggregate statistics as allowed by the policy author.

From a technical perspective, the Aggregator can be realized using a Hardware Security Module (HSM) or other high-assurance computing system such as Intel's SGX processor. These are programmable systems that are designed to perform calculations on secret data; each contains both logical and physical countermeasures that prevent access to internal data, and also prevent tampering with the program logic being run. Some systems, such as Intel SGX, also contain the ability to generate software attestation signatures. These signatures allow the trusted system to produce outputs, and “sign” these outputs so that remote parties can be assured that they were generated by a valid processor running a specific program. A statistical aggregator can be realized by specifying such a program and requiring it to publish an attestation along with its public key.

A limitation of the trusted Aggregator approach above is that users must trust that the Aggregator system is behaving correctly, and has not been compromised. An alternative approach removes the need for a trusted aggregator entirely, by using public differential privacy techniques.

Differential privacy techniques are well known in the art. These techniques work by adding statistical “noise” to individual data records, such that these data records do not reveal dispositive information about the data in that record. However, at the same time a collection of many such records can be combined to recover a useful statistical aggregate over the full collection. One well-known technique for this is randomized response: when a party wishes to report a piece of data with two possible values (e.g., yes/no), it can first flip a coin. If the coin reveals “heads,” then it reports the actual answer. However when the coin reveals “tails,” it flips the coin again and reports the result of a second coin flip rather than the actual result. Thus any individual report may either represent a true result, or a meaningless random answer. Hence useful information about a single result cannot be determined. At the same time, any party can compute an approximate sum by tallying many such responses and compensating for the random answers. Over a large enough set of results this provides an answer that is close to the sum of the real data. Differential privacy techniques can generalize this idea to other forms of data, such as numerical data and other textual data (e.g., histograms calculated over sets of arbitrary data elements such as strings; this may be achieved by computing a digest of the necessary elements using a hash function, and then using this to place elements into a Bloom Filter, which is a specialized data structure for recording set membership. Noise can be added to the Bloom Filter.)

To enable this approach, a compliance policy program can specify a Statistical Aggregation Field (SAF) that contains one or more transaction data elements computed by the policy and augmented with an appropriate amount of randomized noise. More concretely, the policy program would be responsible for identifying which transaction data will be used to calculate these reports, how they will be formatted, and precisely how much noise will b44erify44d to obscure the true transaction value. The policy program would also use random numbers provided by the sender wallet to compute the noise-augmented value. Finally, it would combine each reported value into the SAF output. The enforcement techniques described in the previous sections would allow the consensus system participants to verify that the SAF is attached to the transaction data and correctly computed.

Given a number of transactions with such SAF fields, an Aggregator can perform the process of combining SAF data from many transactions. Notice that in this case, the Aggregator need not possess any secret keys, and therefore can be treated as an untrusted party.

Secure Multiparty Computation (MPC), Homomorphic Encryption (HE) and cryptographic Program Obfuscation (PO) are powerful general techniques for performing computation involving private inputs and multiple parties, under integrity and privacy constraints. Where more specialized techniques, such as the above, are not known, available or comparatively inefficient, our system may use MPC, HE or PO to achieve the policy-prescribed behavior.

Cross-Blockchain Operation

The SAP may be configured to preserve CRAI and to enforce compliance policies across transactions involving multiple types of sealed assets and/or multiple blockchain-based consensus systems (or other systems for representing virtual assets), creating a unified compliant pool. In such a configuration, each blockchain may have a different means of integrating CRAI and validating transactions (as discussed above under Sender-transparent policies and blockchain integration).

The SAP may convey CRAI across blockchains by integration with the services that perform asset transfers that involve multiple blockchains, and modify or augment such services to form AASs, for example as described above with reference to Example #12 (Management of decentralized applications) and/or to Example #15 (Lending asset-aware service). In this embodiment, the AASs propagates CRAI from one blockchain to another.

The SAP may also convey CRAI across blockchains by embedding functionality into sealed wallet's software that adds cross-blockchain annotations. For example, in the CRAI that it adds to one blockchains, it can include references to relevant transactions on another blockchain.

Protocols and services that implement cross-blockchain representation of virtual assets are well-known in the art. For example, WBTC (wrapped Bitcoin), tBTC, and renBTC are all existing virtual assets that represent BTC on the Ethereum blockchain, using various mechanisms for creation and redemption of such assets. Such services and protocols may be augmented to form AASs which convey CRAI across blockchains. For example, when a wrapped BTC token is created by depositing a sealed BTC coin, an AAS implementation of wrapped BTC may attach CRAI to the newly-created wrapped BTC token which propagates the CRAI attached to the original BTC coin.

Scalability and Rollups

Some consensus systems have technical characteristics that place limits on the number of transactions that can be recorded within a given time period. These limits are typically a function of the size of the transaction data that must be stored and distributed by the system, as well as the computation time need to verify each transaction. A well-known approach for addressing this problem is to make use of “rollups” in order to compress the amount of data that needs to be stored and verified by the consensus system.

In such a “rollup” arrangement, one or more servers collects sequences of related transactions, and computes a compact representation that stands in for the full sequence. The underlying consensus system thus needs only to verify and store the compact representation (a “rollup summary”), without having to store or verify the original transactions.

Many such arrangements are well-known in the art. For example, “ZK rollups” use cryptographic zero knowledge proof (also called verifiable computing) techniques to produce a short mathematical proof that all transactions represented by the rollup summary were correctly verified, and that the rollup summary represents the final results of evaluating those transactions. This proof can be verified by the consensus system. In “optimistic rollups”, the rollup summary is not accompanied by a mathematical proof that the summary is correct. Instead, the system typically provides an economic incentive for third parties to verify the individual transactions, and allows them to collect a payment. This is done through the use of “fraud proofs” that the consensus system can verify, and assets posted as bonds by the servers, such that the presenter of a fraud proof demonstrating that a given server approved a rollup summary which turned out to be invalid, is thereby entitled to collect that server's bond, thereby also penalizing that server's misbehavior. Rollups can also be realized using multiparty computation protocol, involving a committee of servers, a majority of which needs to approve a rollup summary for this summary to be considered trustworthy; this may be combined with optimistic rollups that penalizes misbehaving committee members.

To ensure high performance on the consensus system, sealed transactions can be processed through a rollup system. This rollup system comprises one or more servers that process transactions received from users, optionally verify the structure of CRAI, and compute a rollup summary from these transactions. The rollup system can then produce, e.g., a verifiable computation or ZK proof that the rollup summary was computed correctly. Alternatively, the rollup system can provide the opportunity for third parties to verify the rollup summary and individual transaction verification, and to produce one or more fraud proofs that allow the consensus system to detect fraud. In the latter case, the rollup system may release a bond, previously posted by the misbehaving server, to the party who presented the fraud proof.

In order to verify the correctness of a transaction involving a sealed asset, the verifying server must validate the correctness of the transaction itself, which is described by the rules of the underlying consensus system. In addition, the server must validate the correctness of the associated CRAI, which is cryptographically bound to the transaction. According to some examples, the underlying consensus system transaction format provides a means to include CRAI within the transaction, and the consensus system verification rules are capable of verifying CRAI. In these cases, the two verification operations will be combined into a single operation. To compute the rollup, the server must verify each transaction and associated CRAI, and compute a summary proof which may contain the output of a hash data structure (e.g., a Merkle tree or “cryptographic accumulator”) over the set of transactions and the inputs and outputs of each transaction. For convenience, this system may generate multiple hash data structures to separately contain the inputs and outputs and other intermediate transaction details. These data structures may be combined to formulate the rollup summary.

To ensure that a rollup server does not omit verification, or produce an incorrect rollup summary, the rollup server may optionally commit to a financial bond (a quantity of virtual assets) that can be released to a third party in the event that the third party is able to identify improper structure in the rollup summary. This may be done through the addition of a “fraud proof” which itself comprises a portion of a Merkle tree that shows that a subcomponent of the rollup summary was not properly computed. Other forms of fraud proof may be supported.

The rollup system ensures that a given sequence of transactions, summarized by a rollup server, is to internally consistent, and does not conflict with other transactions accepted by the consensus system. This is needed to prevent “double spends” and/or situations in which the amount of money sent by a customer exceeds the customer's balance. It is also needed to prevent inconsistencies related to auxiliary information handled by the SAP, such as CRAI attached to the transactions, certificate updates or revocation, and/or policy updates. Accordingly, the rollup system may facilitate ensuring that no conflicting transactions or updates occur in the midst of a series of transactions handled by a rollup server.

This may be accomplished by delegating to one or more designated rollup servers the responsibility for handling all transactions related to a specific compliant pool. In this configuration, transactions affecting the relevant pool cannot be accepted by the consensus system directly, and cannot be accepted by other rollup servers besides the designated servers. The designated servers, for their part, may be configured to ensure that all transactions have a definite ordering and are internally consistent, including all CRAI, certificate updates and revocations, and policy updates. The selection of the server(s) associated with a specific compliant pool may change periodically. According to some examples, multiple servers may simultaneously collect transactions and produce rollups that contain conflicting transactions or ordering, provided that only one rollup is accepted by the consensus system.

A rollup server may be configured to recognize a transactions in which assets are send from a source compliant pool to a destination compliant pool. Moreover, the consensus system and rollup servers may comprise a settlement mechanism configured to extract any necessary information about funds from each rollup server's rollup summary (e.g., knowledge of transfers into a given compliant pool), and deliver this information to the rollup servers that require knowledge of this information. Similarly, CRAI, certificate updates and revocation, and policy updates are delivered to rollups servers which require knowledge of this information.

When such a transfer from one compliant pool to another occurs, a given rollup server may handle these transactions in one of two different ways: (1) a rollup server associated with the source compliant pool may refuse to process later transactions that would spend funds that have been transferred to the destination compliant pool, or (2) the rollup server associated with the source compliant pool can make an exception by allowing for transactions spending funds within the destination compliant pool, provided that it is assured that these transactions will not conflict with transactions managed by other rollup servers. The latter condition may occur, e.g., in situations where later transactions cannot conflict with transactions handled by other servers.

While the description above considers the rollup servers to be distinct from the consensus system, this is only for convenience of description; some or all of the functionality of the rollup servers may be integrated into the consensus system. For example, Central Bank Digital Currencies (CBDCs) may use a centralized system to implement the consensus system, and the same centralized system may also be responsible for accepting transactions and producing rollup summaries. Since these systems are all operated by the same (trusted) party, they may not require proofs that the rollup summary was correctly computed, nor fraud proof mechanisms to detect improper summaries.

Tracing the Regulatory Escrow Provider

A system that provides regulatory escrow (for example as described above) may be configured in any suitable way, for example to accommodate specific permissions for decrypting the escrowed information and/or under which specified condition.

According to some examples, the policy defines a single escrow provider who holds one or more keys that can decrypt all escrow CRAI recorded on the ledger under that policy. The escrow provider may be realized as a committee, which requires a majority or unanimity to approve decryption (e.g., by employing cryptographic threshold signatures). This may occur wherein a single regulatory agency who assumes the role of escrow provider.

According to other examples, the policy defines multiple providers, wherein each provider has decryption keys for only certain transactions made on the network. The escrow providers may be VASPs or exchanges, for example selected for the purpose by a customer, and may or may not be the same parties as the Identity Provider that issued credentials to the users.

According to examples wherein multiple regulatory escrow providers are able to decrypt the CRAI on a specific transaction, a process is required for finding the applicable one for performing the decryption. One or more mechanisms may be provided to accomplish this.

According to some examples, the mechanism includes providing a label within the CRAI in each relevant transaction. This label indicates which escrow provider is capable of decrypting the transaction.

According to other examples, the mechanism includes providing a ciphertext that is encrypted using the key of the escrow provider, such that an attempt to decrypt the ciphertext by the escrow provider will indicate whether decryption succeeded or not. Each provider can then attempt to decrypt the ciphertext with its key, wherein only the one for whom the ciphertext is intended will succeed.

According to further examples, the mechanism defines a third party “escrow identifier” whose role is to examine transactions in order to determine which escrow provider is responsible for each. This party can then direct regulators, investigators, etc., to the relevant escrow provider for each transaction. Accordingly, only this third party (or multiple such third parties) can view this information, and this information is not available to the general public. Each transaction may thus comprise an encrypted identifier for the escrow authority as well as any normal CRAI required for identity escrow. The encryption is performed using a key belonging to the “escrow identifier” party, which can decrypt it. That party then uses the recovered information to direct investigators to the correct location.

Decentralized Applications (DEFI)

In recent years, a number of decentralized financial applications have been deployed to provide financial services for digital currencies. Known as “DeFi” applications, these systems are typically implemented using “smart contracts,” i.e., specialized computer programs that are evaluated by a consensus system, and are capable of controlling the flow of digital assets programmatically. While DeFi applications may have some centralized components (such as order books for exchanges, price oracles, etc.) DeFi systems are generally designed to eschew dependence on centralized entities. The lack of a centralized entity located within a specific jurisdiction can lead to more robust systems; however, it also makes regulatory compliance more challenging.

In the case of centralized applications such as asset exchanges, a compliance policy may designate the party to act as an Asset Aware Service (AAS), which allows it to correctly update the CRAI on outgoing transactions. In decentralized applications, there may be no trusted party that can carry out the corresponding role. This necessitates a system that can correctly record compliance information without the use of a trusted party.

Enforcing the correct provision of CRAI when interacting with DeFi applications can be done in one of several different ways. The selection of which method to use depends on the nature of the DeFi application, for example as will be described below.

User interactions with DeFi applications have several interaction phases, which may be characterized as follows:
a) Deposit: To interact with DeFi, a sealed asset holder sends virtual assets from a sealed wallet to a smart contract address that is controlled by a DeFi application.
b) User interaction: During this phase, the sealed asset holder may interact with the DeFi application by issuing commands that describe how assets are to be processed. In some DeFi applications, this interaction phase does not occur.
c) Third party interaction: In addition to accepting commands from the asset holder, DeFi applications may accept both additional deposits and additional commands from third parties. These third parties may be sealed asset holders, or they may not be participants in a sealed asset system.
d) Withdrawal: The asset holder may withdraw assets from the DeFi application to a sealed wallet. These assets may be the same as the originally deposited assets, or may be of different type and/or quantity.

These interaction phases do not necessarily occur in strict sequence. For example, a DeFi application may accept multiple deposits, withdrawals, and command interactions interleaved in any order. They may also perform one or more simultaneously, e.g., in a trade transaction wherein assets of one type are deposited and assets of another type are simultaneously withdrawn. There may also be duplication or comingling of phases, e.g., in an automatic market maker (AMM) service, in one transaction assets are deposited and a token representing the deposit (a “liquidity provider” token) is withdrawn, and in a subsequent transaction the token is deposited (i.e., redeemed) and assets are withdrawn.

Moreover, there may be interactions other than deposit and withdrawal which may induce events that are considered to have regulatory significance. For example, a DeFi command might instruct the contract to transmit valuable assets to a third party.

Approach #1: White-Listing DeFi Applications

According to some examples, DeFi applications may be supported by designating the entire DeFi application as a trusted application, referred to herein as a Decentralized Asset Aware Service (DAAS). Like a centralized AAS, a DAAS may be configured to enforce the existence of CRAI on deposits and withdrawals from the service. The internal operations of the DAAS that take place after the user deposits assets and prior to the user withdrawing assets are not necessarily deemed relevant to CRAI enforcement. Thus, a user who deposits assets and later withdraws assets will have to attach CRAI to each of these two transactions. But if the smart contract performs operations that involve commingled assets (even those requested by the user), then these operations will not be treated as relevant to CRAI enforcement.

This approach may be suitable wherein internal operations of the smart contract are well-understood by the policy's authors, and it is known that the smart contract itself cannot be used to bypass regulatory enforcement. In such cases, policy authors may be willing to grant exceptions to CRAI processing for specific DeFi applications. An advantage of many DeFi systems is that they are typically based on smart contract programs that can be analyzed and audited by policy authors. Thus, a policy author will know that a specific contract does not perform actions that have a high risk to regulatory compliance. The policy author may therefore include an “allow-list” of permitted smart contract addresses into the policy program. Alternatively, the policy author may specify in the policy program that a signed list of allowed DAAS providers may be provided to the policy as an outside input.

An advantage of this approach is that, owing to the fact that withdrawals and deposits are typically initiated by (from and to) a sealed wallet, the construction of CRAI can be performed by the sealed wallet. The sealed wallet does not necessarily need to be aware of or understand the logic within the smart contract, nor does it need to reason over any commands issued to the application by the sealed wallet owner or third parties.

Indeed, Smart contracts which are deemed too risky for safe usage in a regulatory-compliant infrastructure may be added (e.g., their addresses and/or program code) to a “block-list,” which may be included in the policy program and/or provided to the policy program as a separate input from some trusted source. Thus, users of a sealed asset may never be able to transmit assets to these systems.

Approach #2: Reasoning about DeFi Application Activities

According to other examples, an application may be used in a manner that policy authors consider “mixed,” i.e., the application is viewed as “compliant” when used in one way, but is considered to violate regulatory guarantees and/or increase the regulatory risk associated with assets when used in a different way. For example, a DeFi application in which a policy author performs passive investment might be considered “safe,” but a DeFi application in which the user actively designates payment recipients and loans might not be considered “safe.” Alternatively, the specific set of operations the user performed might be stored into the CRAI so that the system could evaluate them in a more sophisticated manner.

The system may base its CRAI determinations on the specific set of operations that are conducted on the DeFi smart contract between the time that the user deposits assets and the time that the user withdraws them. The set of allowed operations are determined by the policy program. For example, the policy program may not allow the user to withdraw from the contract (with valid CRAI) if certain sets of commands are issued by the user. To satisfy the policy on withdrawal, the user requires some way to prove that the appropriate commands (and only the appropriate commands) were issued. This may be done in one of several ways.

In one embodiment, a separate server component monitors the DeFi application and its transactions on the blockchain. This server component makes a judgement about which commands are taking place and how they affect compliance and risk for different sealed wallets upon withdrawal from this service. When a user wishes to withdraw from the DeFi app, it contacts this server for a judgement. The server provides a digitally signed message containing the requisite information such that this signed message can be provided as an input to the policy program. For example, the server may issue a signed message indicating that no risky actions took place while the sealed wallet had assets deposited in the DeFi app, or it may issue a warning that the user took risky actions, and so on. The policy program will process these messages according to its own program to produce the appropriate CRAI.

In second embodiment, the centralized server is not used. Rather, the owner of each sealed wallet performs the task of monitoring the DeFi application on the blockchain and produces zero knowledge proofs as part of the CRAI, verifying that the commands adhered to policy-prescribed criteria. The statement for this proof can be contained within the policy program. While this embodiment may be less efficient compared to the first embodiment described above, it may mitigate the need to establish and trust servers, for example for complex monitoring tasks.

### Identity Conveyance Systems

As mentioned above, the compliance system may comprise an identity conveyance system configured to facilitate an IP to perform one or more of its functions. According to some examples, the identity conveyance system is configured to facilitate an IP to receive, verify, and/or record customer identity information, and to share portions of this information with service providers in a manner that minimizes the need for service providers to store sensitive customer information. The identity conveyance system may further facilitate customer authorization and control of the dissemination of specific portions of their identity information and/or pseudonyms to chosen providers. It may further be configured to enable the dissemination of this information from an Identity Provider in a manner that allows a service provider to verify its authenticity, for example without the service provider communicating directly with the Identity Provider. This may be enabled by providing customers with a cryptographic identity certificate and/or identity assertion.

According to some examples, the identity conveyance system is further configured to facilitate defining, by service providers, requirements for required identity information, and for Identity Providers to meet these requirements, and to request retention of specific customer information by Identity Providers. It may further allow service providers to compare customer identifiers and to share information about specific customers with Identity Providers and with other service providers, such that this information is bound to the customer's identity.

According to some examples, the identity conveyance system is configured to operate in a centralized configuration, in which information about a customer's identity is stored at a centralized Identity Provider. Service providers interact directly with the centralized identity provider using secure and authenticated network communication channels in order to obtain assertions about customer identity and to send back updated information about the customer's behavior.

According to some examples, the identity conveyance system is configured to operate in a decentralized configuration, in which information about a customer's identity is provided to the customer in a cryptographically authenticated form, wherein the service provider receives a subset of this information from the customer. Updates from the service provider may be stored in various locations, including at the Identity Provider, with the customer (for distribution to other service providers), or on a consensus network ledger such as a blockchain.

According to some examples, the identity conveyance system is configured to operate according to a combination of features of each of the centralized configuration and of the decentralized configuration.

Identity Conveyance System Components

The identity conveyance system may be configured to make assertions about a customer's identity, wherein the customer owns and/or controls one or more digital assets. The identity conveyance system may comprise an Identity Provide, a Service Provider, and a Customer Identity Manager, which are configured to communicate with each other, for example over a computer network.

The Identity Provider (IP) is configured to verify customer identity credentials such as government-issued identification documents, and to securely record information about each customer. The IP may be further configured to issue “identity assertions” to service providers. Such identity assertions may be in the form of digital certificates, and are configured to inform a service provider about identity information, or the existence of identity information at the IP, regarding the customer, in a manner such that the service provider can itself verify.

The Service Provider (SP) is configured to provide one or more financial services to a customer. Examples of SPs may include, but are not limited to, Virtual Asset Service Providers (VASPs), banks, payment processors merchants, credit card issuers, and fund transmission services. An SP may require identity verification in order to perform a transaction with specific customers, and may be configured to receive identity assertions from a trusted Identity Provider. An SP may be configured to interact with one or more SPs tI exchange information about customers, and/or to verify that different SPs are interacting with the same customer.

The Customer Identity Manager (CIM) is configured to allow a customer to interface with Service Providers and Identity Providers. An instance of a CIM may be integrated as a subcomponent of a customer “wallet” configured to control and store digital assets such as cryptocurrency. The CIM is in communication with a computer network, thereby allowing it to send and/or receive messages from the IP and SP systems. The CIM software or hardware may be directly controlled by a customer, and/or may be operated by a service provider on behalf of customers. According to some examples, the CIM in integrated with a wallet which is implemented on dedicated device (a so-called “hardware wallet”) which is only intermittently connected to the internet, for example by connecting to a general-purpose computer connected to the internet. According to some examples, the CIM in integrated with a wallet which is software-based, i.e., implemented on software installed on a general-purpose computer which is continuously connected to the internet. According to some examples, a CIM is partially integrated with a hardware wallet, and partially integrated with a software-based wallet.

There may be multiple instances of each of these components in a given identity conveyance system, and these components are communicatively coupled through a computer network to exchange information among one another. It will be appreciated that the terms IP, SP, and CIM are descriptive of a given set of functionalities, and thus a party may concurrently serve as an IP, SP, and/or CIM.

Identity Conveyance System Operation

During operation, the identity conveyance system performs one or more functions, a non-limiting list of which follows.

Identity verification: In order to establish an identity in the identity conveyance system, the customer communicates with an Identity Provider to convey identity documentation, which is verified by the IP. The document verification may be performed, e.g., in person at a physical location, electronically via a computer network, and/or in any other suitable way or combination thereof. One example of such a process may include, but is not limited to, uploading a photograph of a government-issued identification, one or more bills addressed to the customer, etc., to a website. Identity verification may comprise digital procedures such as direct digital communication with government agencies, and/or the use of digital identity documents contained on “smart cards.”

Once the Identity Provider has verified the customer's identity, it may generate and issue to the customer a digital identity credential. This is a digital file that contains structured information about the user's identity, as well as cryptographic authentication data such as digital signatures computed over this information, using cryptographic keys generated by the Identity Provider. According to some examples, the IP may store the identity information locally.

Service registration: When a customer wishes to register with a new Service Provider, it contacts the service provider through a network connection, such as an HTTP(S) request made to a website or via a mobile app. The customer then indicates with which Identity Provider it has previously registered, and specifies information about its identity. This information may include a subset of the information stored within an Identity Certificate held by the customer, as well as cryptographic information derived from the Identity Certificate. Alternatively, the customer may initiate a direct communication between the Identity Provider and Service Provider, possibly mediated by the customer's computer.

In this process, the customer may reveal a single, specific Identity Provider. Alternatively, the customer may reveal that the identity provider belongs to an authorized set of Identity Providers, without revealing the specific Identity Provider. The latter may be done using cryptographic zero-knowledge proofs that refer, for instance, to a list of certified Identity Providers within the jurisdiction, or to a digital signature certificate issued by a jurisdictional authority that certified the Identity Provider. Moreover, the customer may reveal a plurality of identity providers, such that the separate information that they provide about the customer can be complementary and checked for consistency.

At the conclusion of this process, the service provider obtains relevant information about the customer, thereby verifying that the customer is registered with the Identity Provider and holds an identity in good standing. This information may be associated with the customer's account at the service provider. The information recorded by the service provider may at least partially derive from a combination of information requested by the SP and information that the IP and customer choose to reveal. According to some examples, this information may reveal complete identity information, such as a user's name. According to other examples, the information conveyed will include a “pseudonym,” i.e., an identifier for the customer that differs from the customer's actual identity. The pseudonym is chosen such that it uniquely identifies the customer to the Identity Provider. It may be chosen such that each customer has a single pseudonym shared across multiple SPs it registers with, or an individual pseudonym that is specific to a single provider.

The information thus learned by the service provider may convey attributes of the customer's identity as summaries at coarse granularity, without revealing precise details or supporting evidence. For example, it may reveal the customer's country of citizenship or residence (but not specific address), their age range (but not precise age or birthday), their income range, and/or their net worth range. The identity may also be of negative nature, e.g., that the customer's citizenship is not in a certain deny-list while not disclosing the specific country of citizenship.

Information may be requested by Service Providers for a variety of purposes, including but not limited to compliance with money transmitter, Virtual Asset Service Provider, securities, and/or banking regulations. For example, the requested information may be used to comply with Know Your Customer (KYC), anti-money laundering, counter-terrorism financing and sanctions mandates, to comply with Travel Rule mandates, to ascertain Accredited Investor status (e.g., income, net worth as per Regulation D of the Securities and Exchange Commission), to comply with the Foreign Account Tax Compliance Act (FATCA), and/or to comply with the Fair and Accurate Credit Transactions Act (FACTA), all of which require collection and verification of customer information. The information may also be requested by the Service Provider in order to decide account limits or features for the customer (e.g., option trading, margin or other leverage), and/or to be used as data for custom risk-based policies.

Service provider reporting: Once the service provider has received a customer's identity information from the service provider, it can perform services on behalf of the customer. The nature of these services may be dependent on the specific nature of the provider. The SP may record information that it wishes to associate with the customer's identity. For example, the SP may store information that it only needs locally in its internal database. Moreover, the SP may obtain information that is of interest to other parties in the identity conveyance system. Examples of this information may include, but is not limited to, reports of fraudulent behavior by customers (e.g., “Suspicious Activity Reports”), which may need to be conveyed to regulatory authorities or other parties in the identity conveyance system, or information that could convey useful information about a customers' activity on chain.

To facilitate this recording, the SP may transmit information to the identity provider and/or to other parties that can be usefully combined with identity information. This may be accomplished in a number of ways described further below.

Identity revocation and updates: Parties in the identity conveyance system may provide updates to the identity information held by SPs, and/or revoke an identity assertion previously made. The former may occur when customer information changes at the IP, and this requires new and updated information to be transmitted to the SP. Alternatively, the IP may need to revoke a user's identity rights with one or more service providers. This may occur when, for example, a user's identity information is found to have been accessed fraudulently to register with a service provider. To facilitate this, IPs may from time to time transmit one or more revocation messages to the SPs, either via broadcast messaging or via dedicated messages transmitted thereto. These revocation messages are configured to ensure that the SP will recognize that identity assertions previously made to an SP should no longer be accepted as valid. The mechanisms for this process are described in detail further below.

### Technical and Implementation Considerations

The mechanisms described above may be realized in two different configurations. In the first (“centralized”) configuration, the Identity Provider (or associated servers authorized by the IP) communicate with the Service Provider(s) in real time to convey identity assertions. A benefit of this approach is that it can be realized using many existing web-based technologies such as HTTP, HTTPS, REST APIs, HTML, and web cookies. In the second (“decentralized”) configuration, the IP transmits a cryptographic object to the customer's Customer Identity Manager, which stores this value and can make assertions about its identity directly to SPs. While these two configurations are different, they may overlap in some ways, e.g., the decentralized configuration does not rule out any communication between SP and IP.

Common elements: In each of the configuration, the Identity Provider maintains a database that comprises records about customers. This database will contain information such as customer names, addresses, citizenship, passport details, national identity numbers, digital currency addresses, supporting documentation and verification procedures performed on the individual, as well as arbitrary additional information, e.g., records about customer transaction history and/or credit scores. The Identity Provider may also be configured to summarize some portions of this information into alternative forms, e.g., converting a collection of transaction history data into a “risk score” that provides Service Providers with a snapshot evaluation of the customer's activity.

The IP may further be configured to communicate with a computer network, thereby accessing one or more consensus networks, such as blockchain-based systems (e.g., Bitcoin, Ethereum, etc.). It may use this access to collect additional information about the customer. The IP may also interact through the computer network with customer machines, Customer Identity Managers, Service Providers, and/or other connected components. (A person of ordinary skill in the art will understand that the Identity Provider may itself divide these functions across multiple computers or locations.)

Each Identity Provider and one or more Service Providers may establish a trust relationship. This relationship requires that the Service Provider determine that the IP as a source of authentic identity information. Service Providers may establish trust relationships with multiple Identity Providers, and these trust relationships may be conditioned on specific elements of the identity, e.g., a Service Provider may trust an Identity Provider to validate identities for a specific jurisdiction, but not for other jurisdictions (e.g., it may validate an identity for the United States, but not for France.) The trust relationship may also apply in the reverse direction, e.g., an IP may only support assertions to specific SPs identified in advance, or it may support assertions to any SP.

This trust may be established between individual pairs of Identity Providers and Service Providers, or it may employ a system that marks a plurality of Identity Providers and/or Service Providers as trustworthy, for instance, via a list of certified Identity Providers within the jurisdiction, or via a digital signature certificate issued by a jurisdictional authority.

Centralized configuration: In the centralized configuration, the Identity Provider communicates with the SP in real time, either directly via the communication network or using the customer's computer as an intermediary (see discussion further below.)

A customer may establish a new relationship with a specific Service Provider, and/or may perform an action at a SP that necessitates identity verification. In such a case, the SP and IP may communicate with each other (directly or indirectly) to exchange specific information. This information includes may include, but is not limited to, the following:
1. The SP indicates to the IP specifically what identity information is required. This may include a general description indicating that all available information is required, or that a subset of the identity information is required. A mechanism for specifying this information is described below.
2. The IP then determines whether or not the SP is authorized to receive information about identity, and which data it should receive. This determination process may involve policies local to the IP, including the existence of trust relationships between the IP and the SP. It may also involve a step in which the customer is required to provide explicit authorization for the transfer of information. The decisions about which data to deliver to the SP is made by a component called the Identity Summarization Engine, which we describe in later sections.
3. The IP next delivers information about the customer's identity to the SP. This may comprise a transmission involving a data structure that encodes the identity information into fields. Each field may contain one aspect of the customer's identity information, with all fields bound together as belonging to the same customer. This data structure shall also incorporate a customer identifier value. The IP may also deliver auxiliary records it has received, such as updated risk information from other SPs that is intended for delivery.
4. At some later point, the SP may develop information about a customer (e.g., information about a fraudulent transaction, or updated risk scoring information). At this point, the SP may report information to the IP that can be further used to augment the IP's knowledge about the customer. This information may be stored in the database at the IP, and/or may be stored by a third party using an identifier that is bound to the customer's identity.

The IP may be configured to identify at least a subset of the customer's identity information for delivery to the SP. This “subset” refers to both a literal subset of the identity fields in the database (i.e., some fields are selectively delivered and some are withheld). It may also refer to a process by which information is summarized into a form that provides reduced granularity. For example, a field in the IP database may specify the exact birthdate of the customer; however, the IP may instead deliver an approximate date or age (e.g., “the customer is over 21”) instead of this exact data. The IP may further be configured to generate a “pseudonym” in place of explicit identifying customer information. This may be a customer identifier or number that is unique for this customer between the IP and this SP.

The information delivered to the customer and exchanged with the SP may be delivered in a manner that is secure against unauthorized tampering and/or eavesdropping by intermediaries. This may be accomplished by establishing a secure channel between the SP and IP using the Transport Layer Security (TLS) protocol, which provides encrypted and cryptographically authenticated communications between two machines over an Internet Protocol connection. However, alternative mechanisms may be used as well: for example, the Identity Provider may deliver information to the SP through the use of web-based redirects and other standard web technologies, provided this information is cryptographically authenticated in order to prevent tampering. A person of ordinary skill in the art will recognize many common techniques for such communications exist, including the JSON Web Tokens standard.

The IP may be thus configured to deliver customer identity information securely to the SP while ensuring that confidentiality and authenticity are maintained, and that only necessary customer identification information is revealed to the SP. The IP also establishes a customer-unique identifier with the SP so that further communications regarding this customer can be uniquely referenced as part of the IP/SP communication.

A variant of the above mechanism, which will be familiar to one of ordinary skill in the art, is that instead of transmitting messages directly between the IP and SP, the IP and SP may exchange messages using the customer's computer (e.g., a web browser) as an intermediary to pass messages between the two. The use of such an intermediary communications mechanism is a common approach in web-based systems such as Single Sign-On systems.

Decentralized configuration: A separate configuration of the identity conveyance system does not require real-time communication between the Identity Provider and Service Provider to authenticate each user. Instead, the customer is provided with a cryptographic certificate that embeds relevant identity information. This certificate may be stored by the customer in a Customer Identity Module (CIM). Additionally, some function of the certificate (e.g., a public portion and/or a commitment/hash of the certificate) may be stored on a public ledger such as a blockchain. The Customer Identity Module is able to communicate with the Service Provider and Identity Provider via a computer network. When a Service Provider requires authentication of a user's identity, it interacts with the CIM to obtain an identity assertion, i.e., a cryptographic object that specifies information about the customer's identity in a cryptographically-authenticated manner, as will be described below.

A customer may establish a new relationship with a specific Service Provider, or may perform an action at a SP that necessitates identity verification. When this occurs, the SP and CIM will communicate (directly or indirectly via a second computer) to exchange specific information. This information may include, but is not limited to, the following:
1. The SP indicates to the CIM specifically what identity information is requested. This may include a general description indicating that all available information is required, or that a subset of the identity information is required. This information request may be done via dedicated communication from the SP, or it may be announced a priori by the SP. In particular, the information request may be attached to an SP's virtual wallet address, thereby notifying would-be customers that all fund transfers involving this virtual wallet are subject to providing the specific requested information.
2. The CIM then determines whether or not the SP is authorized to receive information about identity, and which data it should receive. This determination process may involve policies local to the CIM as well as some policies that are defined by the IP and stored in the customer's Identity Certificate. It may also involve a step in which the customer is required to provide explicit authorization for the transfer of information. The decisions about which data to deliver to the SP is made by a modified variant of the Identity Summarization Engine that is located within the CIM in this configuration.
3. The CIM next delivers information about the customer's identity to the SP. This delivery may consist of a transmission involving a data structure that encodes the identity information into fields. Each field may contain one aspect of the customer's identity information, with all fields bound together as belonging to the same customer. This data structure shall also incorporate a customer identifier value. To ensure that this information is authentic, the CIM may also attach a cryptographic proof (and/or signature) formulated based on the Identity Certificate. This proof can be verified by the SP to ensure that the information is authentic. Optionally the proof may demonstrate that the selective disclosure identified by the Identity Summarization Engine was correctly formulated with respect to some IP policy.
4. The SP may use the information provided by the CIM to optionally request other information about a customer, such as updated information about customer risk scores. This information may be stored at a public location (e.g., posted to a blockchain or stored on a publicly accessible data storage system) or it may be obtained from a private service such as the original IP. The identity and location of this service may be provided to the SP by the CIM as part of the information delivered in step (3), along any customer identifiers and access codes needed to obtain this information.
5. At some later point, the SP may develop new information about a customer (e.g., information about a fraudulent transaction, or updated risk scoring information). At this point, the SP may report information that can be further used to augment the known information about the customer. This information will be sent to a location identified in the previous step (e.g., a public storage location or a private storage location such as the IP). It is bound to a customer identifier at this location. As a further element protecting this data, when it is stored at a public location it may be encrypted. The necessary decryption keys for this data can be included in the Identity Certificate and delivered to the SP from the CIM as part of step (3).

As described above with reference to the centralized configuration, the CIM, with input from the IP, may be configured to identify a subset of the customer's identity information for delivery to the SP. This “subset” may refer to a literal subset of the identity fields in the database (meaning that some fields are selectively delivered and some are withheld). It may also refer to a process by which information is summarized into a form that provides reduced granularity. The CIM or IP may also generate a “pseudonym” in place of explicit identifying customer information. This may be a customer identifier or number that is unique for this customer between the IP and this SP.

As the IP is not necessarily involved in every identity assertion, cryptographic techniques may be provided so that the CIM can assert to the SP useful information about an identity even though the CIM is wholly under the control of the customer (who may be untrustworthy to the SP). To accomplish this, the CIM may be configured to implement one or more cryptographic techniques, e.g., from the field of anonymous credentials and zero-knowledge proofs, to produce a “non-interactive proof of correctness” over each identity assertion. This proof, which is a digital object, is generated by the CIM using the Identity Certificate and other local key material as input, and can be verified by the SP. If the proof verifies, the SP can be assured that the information included in the identity assertion is authentic (that is, it represents a true summarization of the authenticated data in the Identity Certificate.) This may ensure that even a compromised CIM cannot issue false identity assertions to the SP. (A remaining concern is to handle situations in which the Identity Provider “revokes” an Identity Certificate for a customer, or wishes to revise such a certificate with updated information. This will be discussed below.)

The decentralized setting may further support information reporting by the SP. The information provided by the SP may be similar to the reporting described in previous sections. However, the mechanism by which reporting happens can be different. In one embodiment, the SP can report information to the IP directly (as in the centralized setting), and receive updates directly from the IP. However, in other embodiments, the SP may report information to other public and private storage entities, e.g., blockchains, file sharing services, and/or other third parties that merely hold data for delivery to other users. To enable this, the Identity Certificate may contain authentication tokens and the locations for reporting data, so SPs can exchange data via these services. The data reported by the SP may also be encrypted under a cryptographic key specified to the SP by the CIM identity assertion, and reports received by the SP from other SPs may be decrypted using the same cryptographic key (or a related one). This mechanism is described in detail further below.

As the CIM is located at the customer's machine, it may also have access to additional information about the customer's transactions that is not available to the IP. For example, if the CIM is present in the customer's digital “wallet” it may have access to a full list of all past transactions, including recipient information and amounts. This information can also be incorporated into the assertions that the CIM makes to the SP. For example, a CIM may be configured to assert that some transactions have been issued to a specific SP as proof that the customer has an existing relationship with the SP. This information may be provided explicitly (e.g., with reference to explicit transactions on a digital currency network) or it may be summarized using privacy-preserving cryptographic techniques. A standard approach to this is to use a zero-knowledge proof that indicates the existence of a transaction (or transactions) meeting certain criteria on a public-visible cryptocurrency ledger, such as a blockchain. Techniques for computing such proofs have been proposed in the research literature.

Technical Details

Identity Summarization Engine & Identity Request and Assertion Syntax

One advantage of the identity conveyance system described herein is the ability to selectively disclose information to Service Providers, in a manner that can minimize the amount of customer Personal Identifiable Information (PII) about customers that is stored with Service Providers. The decision about which information is disclosed may differ between Service Providers, e.g., for example because different providers have different requirements and different ability to store data securely. (Selective disclosure may involve redacting specific fields, as well as altering some identity information into a less specific form, e.g., reducing precise data into categories or summaries.) To ensure that the identity conveyance system can scale to a large number of Service Providers and customers, the process of selective disclosure may be automated to a large extent.

To enable this process of automated selective disclosure, an Identity Summarization Engine (ISE) may be provided. The ISE is a identity conveyance system that records one or more customer data records, as well as a request from a Service Provider detailing what data is needed, and (optionally) some auxiliary information such as identity policies. The ISE then determines which customer data should be selectively disclosed to the SP, either by selecting specific fields from the customer data or by summarizing the data into a form that is accurate but less specific. An ISE may be operated by the Identity Provider directly (e.g., in the centralized setting) or it may be deployed as part of the Customer Identity Module (CIM).

Operation of the ISE: At a basic level, the ISE takes in a request from a SP, a customer record, and a policy (although it may take in additional information as well.) The role of the ISE is to process each field of the customer data in order to determine (1) if this field should be delivered to the SP, (2) if the field should be omitted from the assertion delivered to the SP, or (3) this field should be summarized with less-specific information (or combined with information in other fields). The operation of the ISE on each field may depend on a policy, which may dictate, e.g., which information should be delivered, summarized, or withheld, for example on an SP-specific basis.

The information used by the ISE may vary between implementations. For example, the SP request may contain detailed information about what fields the SP requires, or it may contain no such details. The policy may be expressed in a general-purpose computer programming language, or a scripting language, that encodes rules for processing each field, and may be Turing-complete. Alternatively, it may simply describe a more restricted set of rules that can be interpreted by a data processing system to determine which action to take with each field.

Identity Request and Assertion Language: In order to realize the ISE, the identity conveyance system according to some examples may specify a Request Language for specifying Identity Requests from SPs as well as Identity Assertions made to SPs. The Request Language specifies which identity fields the SP requires and at what granularity, in a machine-readable format (e.g., JSON-like). For example, the SP may specify a tuple of required fields such as:
required_fields={full_name, age, investor_status, legal_jurisdiction}
   wherein each of the above token names represents a standard piece of information stored within the customer record. Additionally, the SP may identify that specific fields can be delivered in summarized form. For example, an SP request may indicate that it only requests to know “whether the customer is over 21 years of age”. This can be expressed in a number of possible formats. The SP may also identify when an identity field can be treated as optional, or replaced with a placeholder (e.g., a pseudonym in place of a customer name). For example:
required_fields={full_name, age:{>=21}, investor_status, legal_jurisdiction={!=“EU”}}
   may indicate that the SP is requesting only to know that the customer is at least 21 years of age, and that the customer is explicitly not in the “EU” jurisdiction.

Any request may be processed by the ISE in order to determine whether this information can be delivered to the SP, and (if allowed) each necessary field can be extracted from the customer data record and delivered to the SP. The response message is expressed in an Assertion Language, i.e., a machine-readable format that contains the requested data, and may moreover contain customer identifiers and fields for facilitating updates. For example:

```
{
  “Customer_id”, 9“348723483”
″full_name″: “Arthur Wallace Peterson”,
  “age”: 43,
  “investor_status”: “accredited”,
  “legal_jurisdiction”: “US”,
  “update_location”: “https://identity-provider.com/updates”
  “update_token”: “932hbc0wehraehamsnebkaadk2efsvds2bzkhbjWz”
}
```

The Assertion Language message may include components in response to specific requests (e.g., specifying customer data records). It may also include standard elements such as the ability to identify when information fields have been redacted or summarized. For example, the following response might indicate a summarization that is responsive to the second query described above, and also indicates that the investor status component of the record has been redacted due to a policy lim“tation:

```
}
  ″Customer_id”, 9“348723483”
″full_name″: “Arthur Wallace Peterson”,
  “age”[>=21]: TRUE,
  “investor_status”: {null, not_available_with_policy},
  “legal_jurisdiction”[!=EU]: TRUE,
  “update_location”: “https://identity-provider.com/updates”
  “update_token”: “932hbc0wehraehamsnebkaadk2efsvds2bzkhbjWz”
}
```

The above examples are one of what a request and response language might look like. A full implementation might use a different notation, e.g., for interoperability with standard conventions, or for compactness.

As illustrated above, an identity assertion may also include a location at which updated information and customer revocation information may be found. This may be identified by a URL, and may also contain identifiers such as authorization tokens (e.g., passwords) and decryption keys that are needed in order to access data and decrypt retrieved information.

Policies: In addition to the SP request and customer data, the ISE may be configured to take as input one or more policies selected by the Identity Provider. These policies, together with the SP request, allow the ISE to determine which fields should be returned and which should be summarized or redacted. As discussed above, the policies may comprise computer programs or scripts that can operate over the elements of the SP request and customer data, and/or make determinations about how to output or summarize data. Alternatively, policies can simply specify basic rules that the ISE can evaluate against this data in order to make decisions.

It will be appreciated that while the policies are described above as operating over the full SP request and customer data, they may also reason over partial customer data. For example, customer data may contain only the names of the fields in the customer record, and the ISE can output instructions on which fields should be summarized or omitted.

Cryptographic Authentication

In order to accept a new identity assertion, the SP must ensure that the assertion is authentic. This implies two things: (1) that the identity assertion is consistent with information held by the Identity Provider, and optionally (2) that the specific decisions about which information to send, omit and summarize are authorized by the Identity Provider.

Centralized setting: In the centralized setting, the IP and SP communicate in real time, either directly or optionally using the customer's computer as an intermediary. In this setting, cryptographic authentication is handled in various ways:
1. For direct communication between the SP and the IP, the two parties can use the Transport Layer Security protocol (formerly known as SSL). This protocol provides one-sided or mutual authentication of the two parties using digital certificates, and establishes an encrypted and authenticated connection between the two. An SP that initiates such a connection directly to the IP can verify the authenticity of all data received over the connection, including identity assertions, because the cryptographic protocol ensures that the connection is valid, and that the data received is authentic, e.g., protected against modification or data insertion by third parties.
2. For indirect communication between the SP and the IP, the two parties can employ digital signatures or Message Authentication Codes to authenticate messages delivered between from the IP to the SP. These values can be delivered e.g., via JWT tokens or URLs. A number of practical solutions to delivering encrypted and authenticated information between two systems via an intermediary's web browser are known in the literature.

It will be appreciated that as Identity Assertions derive directly from the Identity Provider in this setting, any time the SP can verify that an assertion is authentic, the SP may also be configured to verify that the summarization of the identity information was also determined by the IP. This may obviate the need to provide a further cryptographic mechanism to prove to the SP that this is true.

Decentralized setting: In this setting, the IP provides the customer (specifically, the Customer Identity Manager component) with an Identity Certificate that contains relevant details about the customer's identity. The CIM must then make identity assertions to the SP that the SP can verify as authentic.

According to some examples, an identity assertion from the CIM to the SIP is made by transmitting the entire Identity Certificate from the CIM to the SP without any selective disclosure or summarization of fields. In this setting, the Identity Certificate may contain a digital signature over its contents formulated by the Identity Provider. Upon receiving the Identity Certificate, the SP can verify that the certificate is valid (i.e., produced by the IP) by verifying that the signature is valid with respect to the IP's public key. (It will be appreciated that a digital signature is a cryptographic object analogous to a real signature, in that it proves the authenticity of a document. Regarding a digital signature, a signing party [in this case the IP] holds a secret key that can make a signature on any message [the Identity Certificate Data] such that this signature can be verified as authentic using a second, related “public key” issued to all parties by the IP.)

According to some examples, the identity conveyance system is configured to allow selective disclosure while allowing the SP to verify authenticity.

According to some examples in which selective disclosure while allowing the SP to verify authenticity is allowed, the IP is configured to compute a digital commitment to each data field, and then to combine all of the commitment values and signs the combined result. The Identity Certificate comprises the full list of digital commitments along with signature, and the CIM is also given the plaintext list of data fields and commitment “opening” values for each field. When the CIM transmits an Identity Assertion to the SP, it transmits the full Identity Certificate comprising the commitments and signature, along with the data fields themselves along with “opening” values for all commitments corresponding to data fields that it wishes to reveal to the SP. The SP can then verify the signature is valid, and that each data field and opening value is consistent with the corresponding commitment. (A digital commitment is a cryptographic object that resembles an envelope. To make a commitment, a data field is provided as input, along with some optional random data, and the result is an object called a commitment that does not reveal the contents of the data field, as well as an “opening” value. Given the commitment, the opening value, and the contents, any party can verify that the commitment is consistent. A key property of commitments is that once formulated, a commitment should not be feasible to “open” to a different data value than it was formulated with.)

According to these examples, the CIM may be configured to selectively reveal data fields to the SP. For those fields the CIM wishes to selectively reveal, it may be configured to provide the data field and commitment opening (in addition to the commitment contained in the Identity Certificate). For those the CIM does not wish to reveal, it omits the data field and commitment opening. The SP can then be assured that all selectively-revealed values are consistent and authentic with the Identity Certificate, but the SP does not learn any values that the CIM chooses not to reveal.

It will be appreciated that a number of variants of this structure, which may be more efficient, are possible. For example, the IP may elect to compute a Merkle hash tree over tree over all of the commitments, which may be included at the leaves of a hash tree, and reveal portions of the hash tree in order to satisfy the SP that all revealed values are correct. The CIM may transmit some portions of the Merkle hash tree for values it wishes to reveal. According to this approach, the amount of data transmitted to the SP may be sublinear in the number of fields in the identity certificate.

The approach above may facilitate selective disclosure of fields in the Identity Certificate. In order to provide summarization, a cryptographic method that enables the CIM to reveal a mathematical function of one or more fields in the Identity Certificate without revealing the original values in the Certificate may be, and to convince the SP that this function was computed correctly, may be provided. For example, a mathematical function might take as input the age of a customer, and output “TRUE” if the customer is over 21 years of age. Other functions might translate customer information into less-precise representations e.g., by “bucketing” information or otherwise summarizing it.

An alternative embodiment of the decentralized setting uses “anonymous credential” techniques to allow for the CIM to create Identity Assertions. A series of cryptographic techniques are known for making cryptographic assertions over structured authenticated documents. In this paradigm, a central “authority” cryptographically signs a document called a “credential” that contains information, for example comprising multiple fields. This credential may be signed directly by the authority and given to a user, or it may be signed using a “blind signature” in such a way that a person who possesses the credential information can interact with the authority to obtain a signature on this credential, without the authority learning any (or some) information on the credential. Subsequently, the user holding the signed document can generate assertions over specific contents of the credential: for example, the user can “show” the credential by producing cryptographic messages that indicate a proof to some third party (called a “verifier”) that they possess such a credential, or that the credential contains specific information. This verifier party may be the same party as the original authority, or the verifier may be a third party. Such “anonymous credentials” may ensure that the credential “show” messages are not easily linked back to the original credential signed by the authority. Thus, if an authority has signed many credentials and subsequently sees the “show” messages for a credential, it should not be able to determine which of these credentials is being shown. Similarly, it should not be feasible for a user to “show” a credential that they were not issued by the authority, without this fraudulent activity being detected by the verifier. Suitable anonymous credentials are well-known in the art.

A more powerful variant of anonymous credentials use “signatures with efficient protocols,” which are also well-known in the art. This variant defines a signature scheme that can sign a multi-field anonymous credential, and allows the user to prove arbitrary functions over the signed data. For example, a user who holds a signed credential can simply reveal a field of the credential, can omit a field of the credential, or can publish a zero-knowledge proof of knowledge that they have input fields from a signed credential that satisfy some mathematical function. This mathematical function can be a summarization function that maps input fields to a summarized input. The nature of this process is that a “credential show” can reveal a summarization of one or more fields of the credential, and prove that the user performing the show has a credential that is consistent with this summarization. These signatures can be realized from signatures based on the Strong RSA assumption, bilinear maps, and other cryptographic techniques.

According to some examples, the decentralized setting uses such an anonymous credential as follows. To obtain an Identity Certificate, the CIM obtains an anonymous credential over the customer's identity information. This signed information may be stored in a multi-field anonymous credential and delivered to the CIM using a blind signature extraction protocol, or simply by having the IP sign the credential and deliver it to the CIM. When the SP requires an Identity Assertion from the CIM, the ISE system on the CIM now evaluates a policy that is also stored in the CIM, and determines precisely which fields of the Certificate should be revealed to the SP and which should be summarized. For those fields which should be summarized, the CIM now derives a mathematical summarization function over the fields of the certificate and outputs the summarized value. Finally, it computes a credential “show,” which is a cryptographic message that proves that the revealed summarization is consistent with the signed certificate.

One example of summarization is to develop a pseudonym for a user that is unique to each exchange. An Identity Certificate should contain a customer identifier that is specific to the Identity Provider. However, the IP and CIM may not wish to reveal this unique identity information to the SP, but my instead wish to generate a “pseudo-identifier” for each SP. To handle this case, the CIM may be configured to employ a summarization function that “entangles” the customer identifier with an SP-specific identifier to obtain a pseudo-ID that is specific to the SP. This summarization function may be, for example, a function such as a pseudorandom function in which the key is the customer identifier, and the input to the function is the unique identifier of the SP.

Reporting

As mentioned above, an SP may be configured to produce additional information that must be stored at the Identity Provider and/or distributed to other Service Providers. Such information may include, but is not limited to, information about fraudulent transactions produced by a customer, or new information about a customer's activity. This information may be intended for delivery to all participants in the system, or it may be restricted to specific parties.

As discussed above, in both the centralized and decentralized settings, information may be reported by transmitting it directly to the Identity Provider. This can be accomplished by delivering a reporting location (e.g., a URL) to the SP as part of the identity certificate. This URL may be associated with one or more API keys or authentication tokens, which allow access. To report new information, the SP establishes communication with the IP and transmits information in a secure manner, e.g., via an HTTP(S) connection. This information is then recorded into a database by the Identity Provider, and may be processed for later delivery to other customers and SPs.

According to some examples, for example when the identity conveyance system operates according to the decentralized setting, this information may be delivered to other SPs via a broadcast channel or storage system. One such channel is the use of a consensus network such as a blockchain.

Multiple Identity Providers

In some embodiments, a single Identity Provider may not be solely responsible for carrying a customer's identity information and/or storing reported information. For example, a customer's identity information might be divided across several Identity Providers that work in concert to provide Identity Assertions. This mechanism can be realized by establishing a unique customer identifier across all providers, and having each provider produce a partial Identity Assertion or Identity Certificate that contains relevant information held by that Identity Provider. These can be combined according to the customer identifier in order to assemble a complete Assertion at the SP, or a complete set of information for use as an Identity Certificate at the CIM.

Similarly, information reported by SPs may be stored at multiple distinct locations. Provided that this information is identified by some identifier that allows individual reporting values to be linked together, this information can be obtained by SPs and other interested parties and combined to obtain a complete picture of the necessary reported information.

Revocation and Freshness of Certificates

From time to time, an issued Identity Certificate or Identity Assertion may become invalid, or may contain information that has been supplanted by new information that is available to the Identity Provider. To handle this case, each Identity Certificate and Identity Assertion may contain any of the following four fields: an identity for the assertion/certificate, an expiration date for the assertion/certificate, instructions (such as a URL) to use in order to obtain updated information about the assertion/certificate, and a recommendation for how often each certificate should be updated.

In the centralized setting, the SP which receives an assertion from the IP may optionally receive these fields as part of the assertion. The SP can use this information to determine whether an assertion has reached its expiration date through the mechanism of comparing the expiration date to the current time. Similarly, in the decentralized setting the CIM may compare the expiration date to the current time in order to determine whether the Identity Certificate has expired and must be refreshed. Moreover, in the decentralized setting the CIM may transmit to the SP either (1) the Identity Certificate expiration date, or (2) a summarization of the Identity Certificate expiration date, in a fo70erifyan be verified as authentic by the SP. Examples of such a summarization may include, but are not limited to, a summary that indicates approximately when the Identity Certificate expires, or simply an indicator that indicates that, as of the current time, the Identity Certificate has not yet expired. This may be required in order to ensure that assertions made by the CIM to an SP do not leak the exact expiration date of the certificate, since this information may reveal information to the SP that allows the SP to link different identity assertions by the CIM to the same Identity Certificate, if this information is supposed to be hidden.

The IP may be configured to revoke and/or update the information in an Identity Assertion or Identity Certificate prior to the expiration date. This may occur, for example, when new information arrives at the IP that changes the status of a customer, e.g., a stolen Identity Certificate or evidence of fraudulent intent. To address this case, the IP may be configured to publish a “revocation” message to one or more SPs that allow the SP to determine that one or more customer identities must be updated. This message may include the assertion or Identity Certificate identifier.

The identifier associated with the identity assertion received by the SP may be unique for a customer, but shared across all SPs, or it may be a distinct identifier used for each SP/IP combination to identify a single customer, as discussed in previous sections.

A number of protocols exist for the revocation of standard PKI certificates such as those used to secure web sites. These include Certificate Revocation Lists (CRLs) and the Online Certificate Status Protocol (OCSP), which are used to signal that a given certificate has been revoked. These protocols can be applied with minor modifications to the Identity Certificates and Assertions described above, or specific protocols with a similar purpose may be used in their place. To use a Certificate Revocation List, the Identity Provider will publish a list containing identifiers of all revoked Identity Certificates and/or Assertions. In the OCSP example, each Service Provider will periodically contact the Identity Provider to request whether a given certificate/assertion identifier has been revoked. A final variant of this approach is related to the process of “OCSP stapling,” in which a client such as the CIM can contact the IP to obtain a digitally-signed file indicating that the Identity Certificate is still valid and unrevoked. This file contains a “period of validity” indicating when this file should be considered valid for (e.g., up to three days from the time it is requested.) The CIM can then attach, or “staple”, the file to the Identity Assertion made to the SP. Alternatively, the CIM can summarize the contents of this file using the techniques described for Identity Certificates. This removes the need for the SP to communicate directly with the IP, and removes some resource costs from the SP in checking that a certificate is still valid.

As an alternative to full revocation, an IP may wish to simply update the contents of an Identity Assertion or Identity Certificate. The mechanism for this is similar to revocation, except that the IP should indicate as part of the message it publishes (e.g., CRL or OCSP message) that the certificate/assertion has not been revoked: that rather the parties should obtain an updated certificate from the IP. In the centralized setting, the SP will then contact the IP as described in previous sections to obtain a new/updated assertion. In the decentralized setting, the CIM will contact the IP to obtain an updated Identity Certificate, and the SP may need to obtain a fresh assertion from the CIM.

Those skilled in the art to which this invention pertains will readily appreciate that numerous changes, variations, and modifications can be made without departing from the scope of the presently disclosed subject matter, mutatis mutandis.

1. A computer-implemented compliance system configured to manage transactions over a digital asset network according to a compliance policy, said digital asset network being configured to enforce rules governing recording transactions on a public ledger, the compliance system being configured to:
determine that a requested transaction is in compliance with the compliance policy;
generate at least partially encrypted compliance relevant auxiliary information (CRAI), said CRAI comprising information configured to facilitate independent verification of said compliance; and
associate at least a portion of said CRAI with transaction information stored on the public ledger, and store the associated CRAI in a storage location accessible via the digital asset network.

2. The compliance system according to claim 1, being further configured to:
associate encrypted regulatory information with one or more of a user's transactions, said regulatory information being decryptable by a relevant regulatory agent;
generate a report comprising information about the one or more transactions; and
cryptographically store the report with the associated regulatory information.

3. The compliance system according to claim 2, said compliance policy defining one or more conditions constituting suspicious activity, the compliance system being configured to determine that the one or more transactions constitutes the defined suspicious activity.

4-9. (canceled)

10. The compliance system according to claim 1, said compliance policy defining one or more attributes of a forbidden transaction, said compliance system being configured to block execution of a transaction deemed forbidden by the compliance policy.

11. The compliance system according to claim 1, said compliance policy defining one or more attributes of a transaction requiring a deduction, said compliance policy being configured to identify when a transaction requires a deduction, calculate the amount of the deduction, and initiate a transaction to satisfy the required deduction.

12. (canceled)

13. The compliance system according to claim 1, comprising a plurality of sealed wallets defined by the compliance policy, said sealed wallets being configured to reason over said CRAI to determine if a requested transaction is in compliance with the compliance policy.

14. (canceled)

15. The compliance system according to claim 1, further configured to reason over CRAI associated with one or more transactions.

16. The compliance system according to claim 1, wherein said CRAI comprises a proof that the transaction complies with the compliance policy.

17. The compliance system according to claim 1, wherein said CRAI comprises compliance information relevant to a determination of compliance of a requested transaction with the compliance policy.

18-19. (canceled)

20. The compliance system according to claim 1, further comprising an identity provider configured to verify information corresponding to a user, and to issue an identity certificate to the user upon the verification.

21-22. (canceled)

23. The compliance system according to claim 1, configured to augment a native asset associated with the digital asset network by attaching CRAI thereto in accordance with the compliance policy, thereby producing a sealed asset.

24. The compliance system according to claim 23, configured to disassociate CRAI from a sealed asset, thereby extracting the native asset therefrom.

25. The compliance system according to claim 23, further configured to define a compliant pool comprising sealed wallets and sealed assets defined by compatible compliance policies.

26-28. (canceled)

29. The compliance system according to claim 1, wherein said CRAI comprises a regulatory escrow access field configured to facilitate third-party verification of each transaction.

30. The compliance system according to claim 1, further configured to attach to a transaction an encoded mathematical function related to the transaction.

31. The compliance system according to claim 1, further configured to analyze one or more transactions for suspicious activity.

32. The compliance system according to claim 1, wherein encryption of at least some of said CRAI facilitates verification thereof without revealing its contents.

33. (canceled)

34. The compliance system according to claim 1, wherein encryption of at least some of said CRAI is irrecoverable.

35. The compliance system according to claim 1, wherein said transaction information comprises one or more selected from a group consisting of a cryptographic identifier of a sender of the transaction, cryptographic identifier of a recipient of the transaction, and transaction details.

36. The compliance system according to claim 1, wherein the transaction comprises transferring currency.

37-39. (canceled)
